(19) United States
(12) Patent Application Publication
(10) Pub. No.: US 2003/0227554 A1
(43) Pub. Date: Dec. 11, 2003

(54) Digital camera system

(75) Inventors: Kazuyuki Kazami, Itabashi-ku (JP); Hirotake Nozaki, Koto-ku (JP); Masahide Tanaka, Kawasaki-shi (JP); Nobuyuki Kato, Kawaguchi-shi (JP); Akira Ohmura, Shibuya-ku (JP); Tadashi Ohta, Yokohama-shi (JP)

Correspondence Address: OLIFF & BERRIDGE, PLC, P.O. BOX 19928, ALEXANDRIA, VA, 22320, US

(73) Assignees: Nikon Corporation, Tokyo (JP); Nikon Technologies Inc., Tokyo (JP)

(21) Appl. No.: 10/413,142

(22) Filed: Apr. 15, 2003

(30) Foreign Application Priority Data
Apr. 26, 2002 (JP) 2002-126122
Apr. 26, 2002 (JP) 2002-126123
Apr. 26, 2002 (JP) 2002-126124
May 15, 2002 (JP) 2002-139442
May 15, 2002 (JP) 2002-139443
Jun. 28, 2002 (JP) 2002-188836
Mar. 28, 2003 (JP) 2003-089549

(51) Int. Cl. H04N 5/76

(52) U.S. Cl. 348/231.3

(57) ABSTRACT

The object of the present invention is to provide a digital camera capable of outputting image information suitable for using by peripherals. According to one aspect of the present invention, a digital camera includes an input section that inputs special information related to using images by peripherals, a special memory that stores the special information in advance, a processor that processes image information to be an output image data in accordance with each peripheral on the basis of the special information stored in the special memory, and an output section that outputs the output image data processed by the processor to the

### INCORPORATION BY REFERENCE

The disclosures of the following priority applications are herein incorporated by reference:

Japanese Patent Application No. 2002-126122 filed Apr. 26, 2002,

Japanese Patent Application No. 2002-126123 filed Apr. 26, 2002,

Japanese Patent Application No. 2002-126124 filed Apr. 26, 2002,

Japanese Patent Application No. 2002-139443 filed May 15, 2002,

Japanese Patent Application No. 2002-139442 filed May 15, 2002,

Japanese Patent Application No. 2002-188836 filed Jun. 28, 2002, and

Japanese Patent Application No. 2003-89549 filed Mar. 28, 2003.

### BACKGROUND OF THE INVENTION

1. Field of the Invention

The present invention relates to a digital camera system and peripherals such as a printer connecting the same.

2. Description of Related Art

Image information obtained by a digital camera is used by peripherals in various forms such as accumulation, print, processing, transmission, and the like. In the case of print, usually, an image data of a digital camera is input into a personal computer in which a printer driver soft for the printer to be used is installed, and printed. When the printer has a function of expanding a compressed image, it is possible to print by directly inserting a memory card in which a compressed image data is stored into a card slot. Moreover, it has proposed that in order to make color-matching between the digital camera and the printer, a command attached with the image data is transferred to the printer.

In FIG. 1 of Japanese Laid-Open Patent Application No. 9-307927, the idea described below has been proposed. A shot image is converted into a digital image data and stored in a memory 103 and, at the same time, a color reproduction characteristic recording means 107 stores color reproduction characteristics corresponding to output devices capable of being connected to the digital still video camera in the memory 103. When the shot image data is output by an output device or when an image data stored in the memory 103 is reproduced for outputting, reproduction-correction means 107 through 109 provides to the output device the digital image data that is the shot image data processed and corrected on the basis of the color reproduction characteristics stored in the memory 103 or the digital data that is the image data stored in the memory 103 processed with reproduction, conversion, and correction.

In FIG. 1 of Japanese Laid-Open Patent Application No. 10-173833, the idea described below has been proposed. A signal network is formed between a camera 10 and a printer 12 by IrDA type infrared communication interfaces 16 and 18. A conversion software for converting an image data to a print data is transmitted from the printer 12 to the camera 10 if necessary. The camera 10 stores the conversion software in a flash memory for storing a shot image data, converts the image data into a print data by using the conversion software, and transmits to the printer 12 through the infrared interfaces 16 and 18.

In FIG. 1 of Japanese Laid-Open Patent Application No. 10-191226, the idea described below has been proposed. When an image data shot by a digital camera 101 is out put by printing, a print data conversion software and the image data are transmitted from the digital camera 101 by infrared light 105 emitted from an infrared I/F 103, and the print data conversion software and the image data transmitted by infrared light 105 are received by an infrared I/F 104 of the printer 102. The received print data conversion software is started on the printer 102, and the received image data is converted into a print data by the print data conversion software.

Although image information of a digital camera can be used by various peripherals in various ways, you still need more consideration.

### SUMMARY OF THE INVENTION

The present invention is made in view of the aforementioned problems and has an object to provide a digital camera capable of outputting image information suitable for using by peripherals.

According to one aspect of the present invention, a digital camera includes an input section that inputs special information related to using images by peripherals, a special memory that stores the special information in advance, a processor that processes image information to be an output image data in accordance with each peripheral on the basis of the special information stored in the special memory, and an output section that outputs the output image data processed by the processor to the peripheral.

As an example of processing of the above-mentioned processor, there is conversion of resolution and image quality corresponding to the particular peripheral to be used and security processing that carries out electronic watermark processing and encode processing to the image data.

By carrying out security processing such as electronic watermark processing and encode processing in accordance with the image provider an image data can be transferred from a digital camera to a peripheral such as an image provider through the Internet without anxiety for infringement of copyright and embezzlement.

As described above, the digital camera according to the present invention processes image information not only format of information but also contents of information to become an output image data corresponding to the peripheral on the basis of the special information regarding image usage of the peripheral, so that it becomes possible to output special image information corresponding to the purpose of image usage of each peripheral.

In one preferred embodiment of the present invention, the processor includes a working section that works by a software program and wherein the special information is a software program that works the working section. The input section inputs the special information from the peripheral as well as from a network capable of being accessed from the input section. The processed output image data is directly output to the peripheral connected to the output section. The processed output image data may also be output by storing the output image data in the memory medium inserted in a slot of the digital camera and by using a communication means.

In one particular example of the peripheral according to the present invention, there are an image viewer, an image accumulator, and portable communicator. When a portable communicator is the peripheral, the image data processed for an image frame waiting for a call of the portable communicator may be output.

According to another aspect of the present invention, a digital camera includes a special information memory that stores special information corresponding to a peripheral, a data interface that inputs and outputs a data with the peripheral, a peripheral discriminator that discriminates the kind of the peripheral on the basis of the data input from the data interface upon connecting to the peripheral, a special information selector that selects a set of special information among a plurality of sets of special information stored in the special information memory, and a comparator that compares the selected result of the special information selector with the discriminated result of the peripheral discriminator. Therefore, it becomes possible to compare the selected special information with the discriminated special information.

According to another aspect of the present invention, a digital camera includes a special information memory that stores special information corresponding to a peripheral, a data interface that inputs and outputs a data with the peripheral, a peripheral discriminator that discriminates the kind of the peripheral on the basis of the data input from the data interface upon connecting to the peripheral, a special information selector that selects a set of special information among a plurality of sets of special information stored in the special information memory, and a display that displays the selected result of the special information selector and the discriminated result of the peripheral discriminator. Therefore, the user can confirm whether special information is suitably selected or not.

According to another aspect of the present invention, a digital camera includes a peripheral discriminator that discriminates the kind of a connected peripheral, an output way selector that selects the data output way on the basis of the discriminated result of the peripheral discriminator, an output section that outputs a selected data selected by the output way selector, and a display that shows the output way which is the selected data selected by the output selector. Therefore, the digital camera can select a data output way suitable for the connected peripheral and confirm to the user by showing the data output way.

other feature and advantages according to the present invention will be readily understood from the detailed description of the preferred embodiment in conjunction with the accompanying drawings.

### BRIEF DESCRIPTION OF THE DRAWINGS

FIG. 1 is a block diagram showing a digital camera system according to Example 1 of the first embodiment of the present invention.

FIG. 2 is a flow chart showing the main flow of a digital camera 1 according to Example 1 of the first embodiment of the present invention.

FIG. 3 is a flow chart showing flows when a shooting mode interruption is occurred according to Example 1 of the first embodiment of the present invention.

FIG. 4 is a flow chart showing flows when a print mode interruption is occurred according to Example 1 of the first embodiment of the present invention.

FIG. 5 is a flow chart showing detailed process of storing a print instruction in the memory medium.

FIG. 6 is a flowchart showing detailed process of delete mode selection processing.

FIG. 7 is a flowchart showing detailed process of delete processing.

FIG. 8 is a block diagram showing a digital camera system according to Example 2 of the first embodiment of the present invention.

FIG. 9 is a block diagram showing a digital camera system according to Example 3 of the first embodiment of the present invention.

FIG. 10 is a block diagram showing a digital camera system according to Example 4 of a second embodiment of the present invention.

FIG. 11 is a drawing showing a digital camera and typical peripherals connecting to the same.

FIG. 12 is a flow chart explaining procedure of the digital camera according to Example 4 of the second embodiment of the present invention.

FIG. 13 is a block diagram showing a digital camera system when the connected peripheral is a printer.

FIG. 14 is a flowchart showing a procedure of the digital camera system when the connected peripheral is a printer.

FIG. 15 is a block diagram showing a case that the digital camera and the printer shown in FIG. 13 are combined together.

FIG. 16 is a block diagram showing a digital camera system according to Example 5 of the second embodiment of the present invention.

FIG. 17 is a flowchart showing movements of the digital camera shown in FIG. 16.

FIG. 18 is a drawing showing an example of image reproduction on the display.

FIG. 19 is a flowchart showing movements of the digital camera shown in FIG. 16.

FIG. 20 shows an example of a display of the number of remaining frames.

FIG. 21 is a flowchart showing movements of the digital camera shown in FIG. 16.

FIG. 22 shows an example of a display upon deleting an applet program.

FIG. 23 shows an example of a display upon discriminating the connected peripheral.

FIG. 24 shows an example of a display upon selecting an applet program.

FIG. 25 is a drawing showing a digital camera system connecting peripherals according to Example 6 of the second embodiment of the present invention.

FIG. 26 is a flowchart showing movements of the digital camera shown in FIG. 25.

FIG. 27 shows an example of a display upon operating the digital camera shown in FIG. 25.

### DESCRIPTION OF THE PREFERRED EMBODIMENTS

[First Embodiment]

### EXAMPLE 1

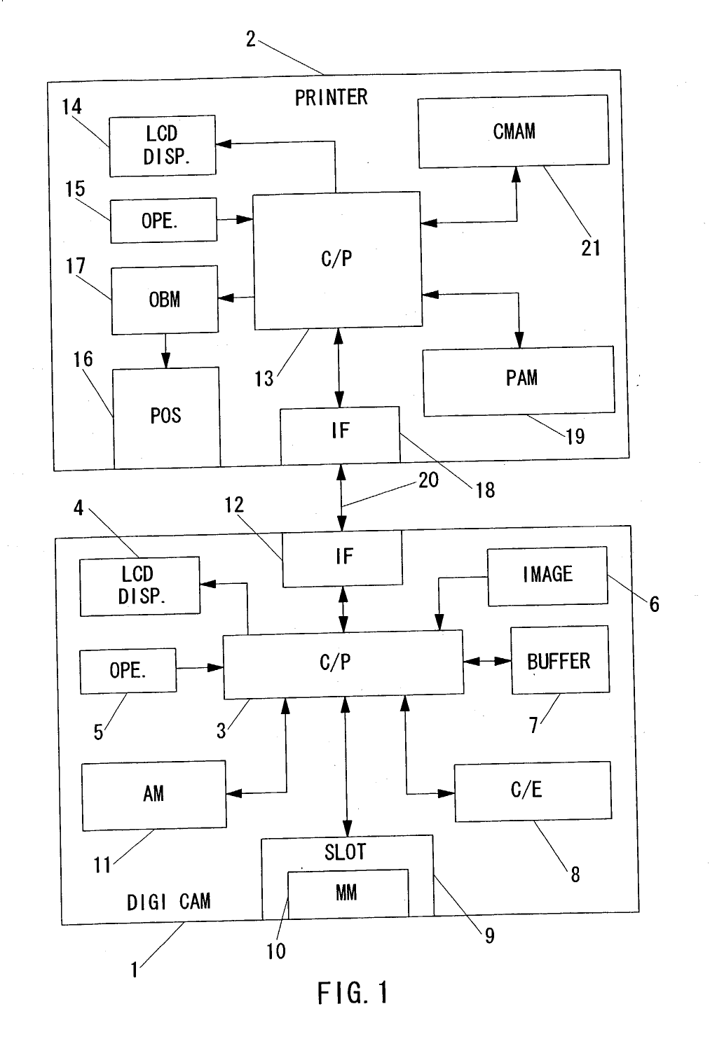

Example 1 of a first embodiment of the present invention is explained below with reference to accompanying drawings. FIG. 1 is a block diagram showing a digital camera system according to Example 1 of the first embodiment of the present invention. The digital camera system is composed of a digital camera 1 and a printer 2.

The digital camera 1 controlled by a controller/processor 3 can be manipulated in various ways from an operating section 5 with reference to a menu shown on an LCD display 4. Since the display data transmitted from the controller/processor 3 is stored in a buffer memory of the LCD display 4, the same display is continuously shown on the LCD display 4 unless the displaying image data in the buffer memory is rewritten by the controller/processor 3. Shooting mode, playback mode, and print mode can be selected from an initial menu displayed on the LCD display 4.

When the shooting mode is selected, an object image is transformed to electronic image signals repeatedly by an imaging section 6 having an imaging lens and an image sensor of about 3 megapixels. Until a shutter is released by the operating section 5, image signals are read out with pixel skipping at the imaging section 6 controlled by the controller/processor 3 and transformed to a pixel-skipping image data by an A/D converter of the imaging section 6 to be transferred to the controller/processor 3. The controller/processor 3 converts the pixel-skipping image data into a display image data by carrying out interpolation, color balance adjustment, and the like to transfer to the buffer memory of the LCD display 4. Since the imaging section 6 shoots image repeatedly, pixel-skipping image data is also transferred to the controller/processor 3 repeatedly, so that the buffer memory of the LCD display 4 is rewritten by a new display image data one after another. Accordingly, the image repeatedly shot by the imaging section 6 is monitored as an animation by the LCD display 4, so the LCD display 4 functions as an electronic viewfinder of the digital camera 1.

When a shutter release button of the operating section 5 is pressed, the readout at the imaging section 6 becomes all-pixel readout. The readout data is converted by the A/D converter to be transferred to the controller/processor 3. The digital data in this state is a raw data output from the image sensor of the imaging section 6 and is called as a “Raw data”. The Raw data is transferred and temporarily memorized in a buffer memory 7. When the memorizing operation of the Raw data has completed, the readout at the imaging section 6 returns to the readout with pixel skipping and the animation monitoring is resumed by the LCD display 4.

The Raw data in the buffer 7 is suitably read out by the controller/processor 3, carried out interpolation, color balance adjustment, and the like, transferred to a compression/expansion section 8 to be transformed into a compressed image data, and returned to the buffer memory 7 to be temporarily memorized. The compressed image data in the buffer memory 7 is suitably read out by the controller/processor 3 and written as an image file on a memory medium 10 such as a memory card put in a memory medium slot 9 in a changeable manner.

The buffer memory 7 has memory capacity of about 10 image frames of Raw data and can store up to 10 image frames in response to the operation of the shutter release button. The Raw data stored in the buffer memory 7 is suitably read out, returned by converted into compressed image data, and further suitably read out to be stored on the memory medium 10. Then, a Raw data which is confirmed to be converted into a compressed image data or a compressed image data which is confirmed to be stored on the memory medium 10 is deleted from the buffer memory 7 or allowed to be overwritten. Accordingly, unless extremely consecutive shooting is carried out, vacant memory capacity of a plurality of image frames is usually secured in the buffer memory 7, so that new Raw data can be stored at any time without waiting. The digital camera 1 further includes an applet memory 11 and an interface 12, which are explained later in connection with the construction of the printer 2.

When a playback mode is selected, thumbnail data is read out from an image file of the memory medium 10 by the controller/processor 3 and displayed on the LCD display 4. When one of thumbnail images is selected by operating the operating section 5, a compressed image data is read out from the selected image file and transferred to the compression/expansion section 8 to be expanded. The expanded image data is carried out suitable pixel skipping and transferred from the controller/processor 3 to the LCD display 4 to be displayed.

The printer 2 is controlled by a controller/processor 13, so that various operations can be carried out by an operating section 15 with watching a menu displayed on a LCD display 14. Since the display data transmitted from the controller/processor 13 is stored in a buffer memory of the LCD display 14, the same display is continuously shown on the LCD display 14 unless the displaying image data in the buffer memory is rewritten by the controller/processor 13. A print output section 16 carries out printing on an output paper based on a print data stored in a buffer memory 17.

The printer 2 does not have an expanding function of a compressed image data. Accordingly, it is necessary that a data expanded and converted to a print data is input to an interface 18. A printer driver applet memory 19 stores a printer driver applet that is application software for converting an expanded compressed image data into a special print data for the printer 2 and transferring the data to the printer 2. The printer driver applet is transferred from the interface 18 to the interface 12 of the digital camera 1 through a cable 20, and memorized in the applet memory 11.

The printer driver applet accompanies with a print menu applet that displays a special menu for the printer 2 for designating a kind, and a size of the paper, image size, image quality, color setting, the number of prints, and the like relative to the printer 2, and selects the items.

In the print mode, when selecting a target image and instructing a print by the operating section 5 of the digital camera 1 in accordance with the controller/processor 3 worked by the print menu applet accompanying with the printer driver applet in the applet memory 11, the compressed target image is read out from the memory medium 10 and expanded by the compression/expansion section 8. The expanded target image is converted into the special print data for the printer 2 by the controller/processor 3 worked by the printer driver applet stored in the applet memory 11 and transferred from the interface 12 to the interface 18 of the printer through the cable 20. The transferred print data is sent to the output buffer memory 17 by the controller/processor 13. Finally, the print output section 16 carries out printing based on the print data.

As described above, since the printer driver applet is stored in the printer driver applet memory 19 of the printer 2 and transferred into the digital camera 1 to be stored in the applet memory 11, it becomes possible that the printer 2 receives an image data in the form of a special print data for the printer 2 from any digital camera. Accordingly, by using the compression/expansion section 8 and the function of applet stored in the applet memory 11, printing can be carried out by directly connecting the digital camera 1 to the printer 2 without receiving print data through a personal computer installed driver software for the printer 2.

A color-matching applet that is necessary application software with which the digital camera 1 writes color and brightness information of a print target image data as a print command on a given position of an image file of the memory medium 10 is stored in a color-matching applet memory 21 of the printer 2. This is for color-matching of image information between the digital camera 1 and the printer 2.

The printer driver applet is transferred from the interface 18 to the interface 12 of the digital camera 1 in advance and stored in the applet memory 11.

The color-matching applet stored in the applet memory 11 is read out from the memory medium 10 in the print mode and used when an expanded image data is converted into a special print data for the printer 2. The print data is transferred from the interface 12 to the interface 18 as a color-matched data. When a printing is carried out by a printer capable of printing by inserting the memory medium 10, the print command of the image file stored in the memory medium 10 is use by the printer.

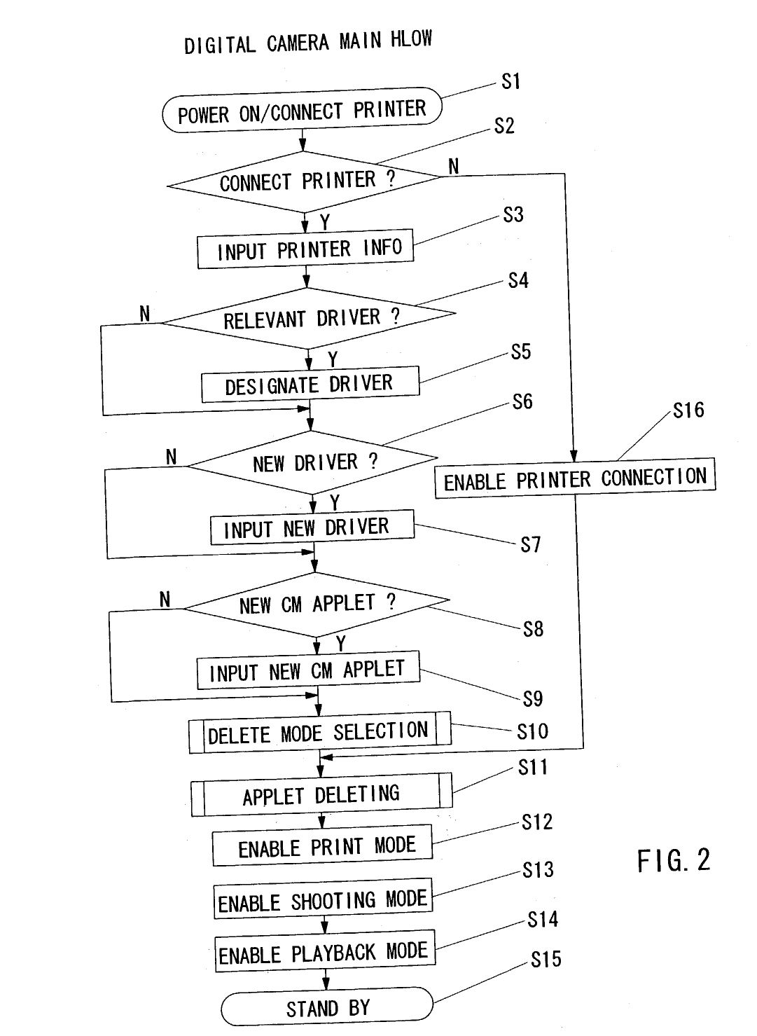

FIG. 2 is a flow chart showing the main flow of a digital camera 1 according to Example 1 of the first embodiment of the present invention. When a printer connection interruption is occurred by turning on a power switch or connecting the digital camera 1 to the printer 2 by the cable 20, the main flow starts from step S1. In step S2, whether the printer is connected or not is checked. When the printer is connected, the flow proceeds to step S3. In step S3, printer information for identifying the printer is input from the printer to the digital camera 1.

In step S4, whether a printer driver applet corresponding to the printer identified by the printer has already input in the applet memory 11 or not is checked. When it has already input, the flow proceeds to step S5. In step S5, the printer driver applet is designated. This is for designating the applet to be used when a plurality of printer driver applets corresponding to a plurality of printers are stored in the applet memory 11.

In step S6, whether the applet stored in the printer driver applet memory 19 is new or not to the digital camera 1 based on the printer information. When the flow comes to step S6 through step S5, step S6 checks whether a printer driver applet stored in the printer driver applet memory 19 is upgraded or not relative to that already stored in the applet memory 11. On the other hand, in step S4, when the printer driver applet corresponding to the printer does not exist in the applet memory 11, the flow proceeds to step S6 skipping step S5. In this case, the result of the check is usually “Yes”. In either case, when a new applet for the digital camera 1 is stored in the printer driver applet memory 19, the flow proceeds to step S7. In step S7, the new printer driver applet is stored in the applet memory 11. On the other hand, in step S6, when a new applet for the digital camera 1 is not stored in the printer driver applet memory 19, the flow skips step S7.

As described above, steps S6 and S7 have a function that rewrites and renews the applet memory 11 not only when the printer driver applet has not been stored in the applet memory 11 at all but also when although a printer driver applet has already been stored in the applet memory 11, the printer driver applet corresponding to the printer 2 has been upgraded. The renewal is carried out, if necessary, every time when the flow starts from step S1 in response to turning on the power switch or the printer connection interruption.

In step S8, whether the applet stored in the color-matching applet memory 21 is new or not to the digital camera 1 is checked on the basis of the printer information. When a new applet to the digital camera 1 is stored in the color-matching applet memory 21, the flow proceeds to step S9. In step S9, the new color-matching applet is input and stored in the applet memory 11. On the other hand, in step S8, when a new applet to the digital camera 1 is not stored in the color-matching applet memory 21, the flow skips step S9. Similar to steps S6 and S7, steps S8 and S9 have a function that rewrites and renews the applet memory 11 when the color-matching applet in the printer 2 has been upgraded.

In the above-described Example 1, we assume that the color-matching applet is based on a common standard, a new version covers every functions of an old version, and it is not necessary to select one of a plurality of color-matching applets already input in accordance with a printer. However, when a color-matching applet specific for the printer is applied, the above-described example is to be modified and steps similar to steps S4 and S5 are to be inserted before step S8.

Delete mode selection processing in step S10 is processing for selecting a condition for deleting applet stored in the applet memory 11 under given conditions in order to avoid accumulating a lot of useless applets in the applet memory 11. The given conditions are, for example, completion of use and expiration of using term, which will be explained later in detail.

Applet deleting processing in step S11 is a kind of processing for deleting unnecessary applet in accordance with the delete mode set in step S10. Here, applet is deleted according to expiration of using term, which will be explained later in detail.

Steps S12, S13, and S14 enable each interruption processing of print mode, shooting mode, and playback mode, respectively. In step S15, the flow stands by.

In step S2, when the printer is not connected, since the processing in step S3 and after that cannot be carried out, the flow proceeds to step S16. In step S16, printer connecting interruption comes to enable and the flow proceeds to step S11. Accordingly, the flow may be constructed such that when a printer is connected in the state of power-on, printer connecting interruption occurs and the flow starts from step S1 carrying out step S3 and after that.

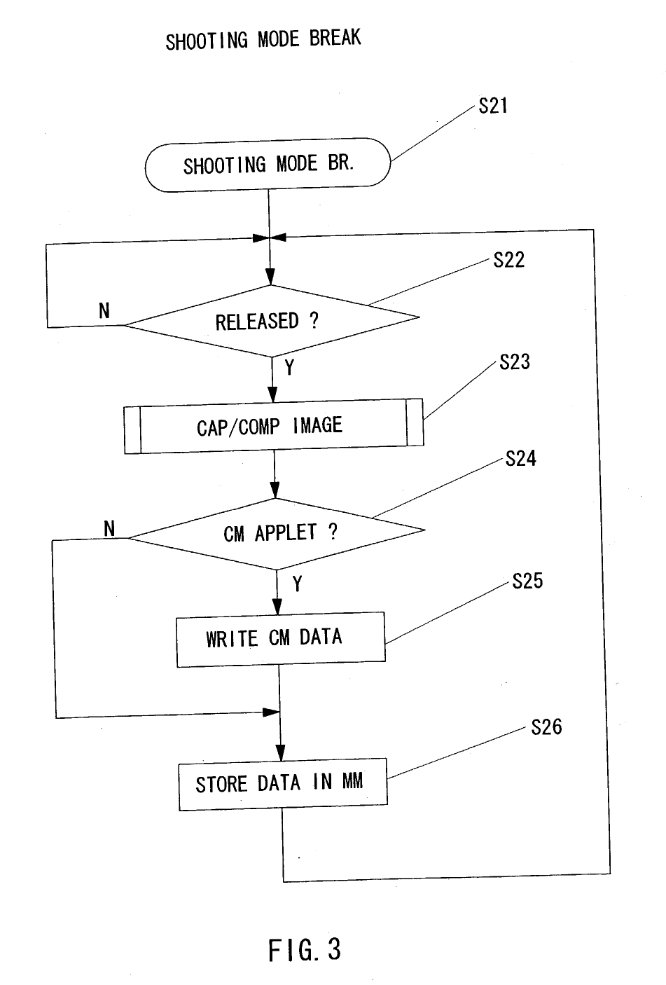

FIG. 3 is a flow chart showing flows when a shooting mode interruption is occurred according to Example 1 of the first embodiment of the present invention. When a shooting mode is selected by the operating section 5, a shooting mode interruption is occurred and the flow starts from step S21. In step S22, the flow waits for shutter release. When the shutter is released, an image data is captured, carried out compression processing, and written on the image file in step S23.

In step S24, whether or not a color-matching applet is stored in the applet memory is checked. When it is stored, the flow proceeds to step S25. In step S25, a color-matching data that is color and brightness information of the shot image data in a form of print command is written on the image file. In step S26, the image file on which compressed image information and print command is written is stored in the memory medium 10. The flow goes back to step S22 and waits for another shutter release. In step S24, when a color-matching applet is not stored in the applet memory 11, the flow skips step S25 and an image file on which image information is written is stored in the memory medium 10.

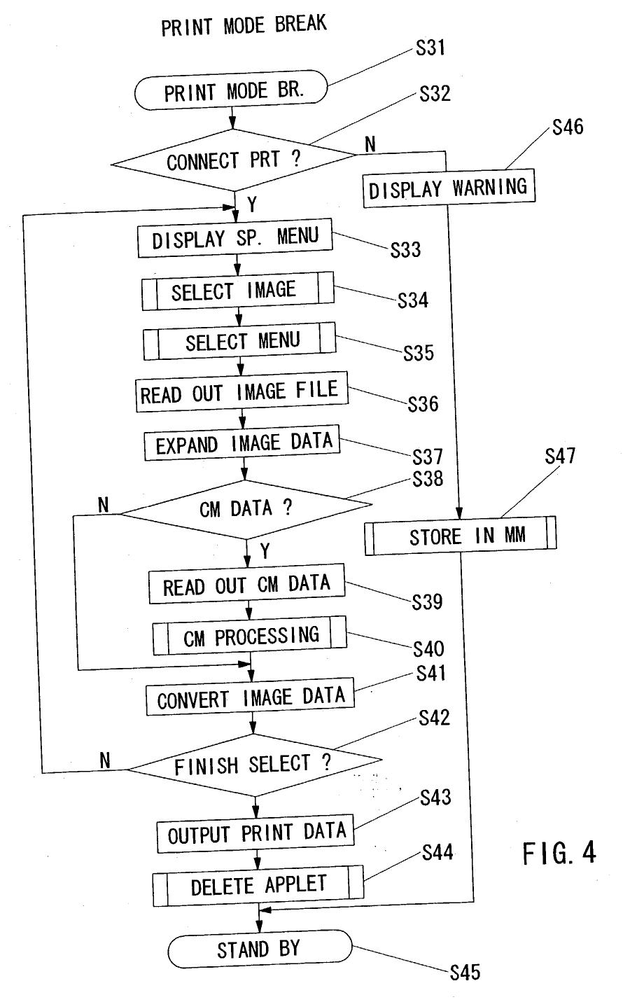

FIG. 4 is a flow chart showing flows when a print mode interruption is occurred according to Example 1 of the first embodiment of the present invention. When a print mode is selected by the operating section 5, a print mode interruption is occurred and the flow starts from step S31. In step S32, whether or not a printer corresponding to direct connection with the digital camera 1 is connected is checked. In other words, whether the printer driver applet of the connected printer is stored in the applet memory 11, and whether the printer 2 can carry out printing by the print data output from the digital camera are checked.

In step S33, when a relevant printer is connected, a printer driver applet corresponding to the printer is read out from the applet memory 11, the controller/processor 3 operates in accordance with the menu applet, and a special menu for the printer 2 is displayed on the LCD display 4. In step S34, a print target image selection processing is carried out in accordance with the displayed menu. In step S35, menu selection processing is carried out in accordance with the displayed menu and a kind of a paper, a paper size, an image size, image quality, color setting, the number of prints, and the like are designated.

In step S36, the image file corresponding to the selected image is read out from the memory medium 10. In step S37, the compressed image data from the image file is expanded by the compression/expansion section 8.

In step S38, whether or not a color-matching data that is color and brightness information of the image data in a form of print command exists in the readout image file is checked. When a color-matching data exists, the flow proceeds to step S39. In step S39, the color-matching data is read out. In step S40, a color-matching processing is carried out to the expanded image data. In step S41, the expanded image data processed with color-matching is converted into a print data. In step S38, when a color-matching data does not exist, the flow jumps to step S41 and the expanded image data is converted to a print data. The converted print data is temporarily stored in the buffer memory 7.

When an applet program for converting image quality and resolution of the image data corresponding to the printer 2 is stored in the applet memory 11, in the aforementioned step S41, the expanded image data is converted into an image data having the resolution and image quality corresponding to the characteristics of the printer 2 before the expanded data is converted into the print data, and then converted into the print data. This function is effective in preventing resolution and image quality from becoming excessively high when the printer 2 is for easy printing such as a small image size.

In step S42, whether or not image selection has completed is checked. When completed, the flow proceeds to step S43. In step S43, the print data stored in the buffer memory 7 is output from the interface 12 to the printer 2. In step S44, applet deleting processing for deleting, if necessary, an already used applet from the applet memory 11 in accordance with a mode selected by the delete mode selection processing in step S10 shown in FIG. 2 is carried out. After the above-described processing, the flow returns to the main flow and stands by in step S45.

In step S42, when image selection has not completed, the flow returns to step S33 and repeats the steps from S33 to S42 until completion of image selection.

In step S32, when a relevant printer is not connected and printing cannot be carried out even if receiving print data from the interface 12, the flow proceeds to step S46 and displays the warning. Then, the flow further proceeds to step S47. In step S47, processing for storing a print instruction in the memory medium 10 is carried out if necessary, and the flow proceeds to step S45.

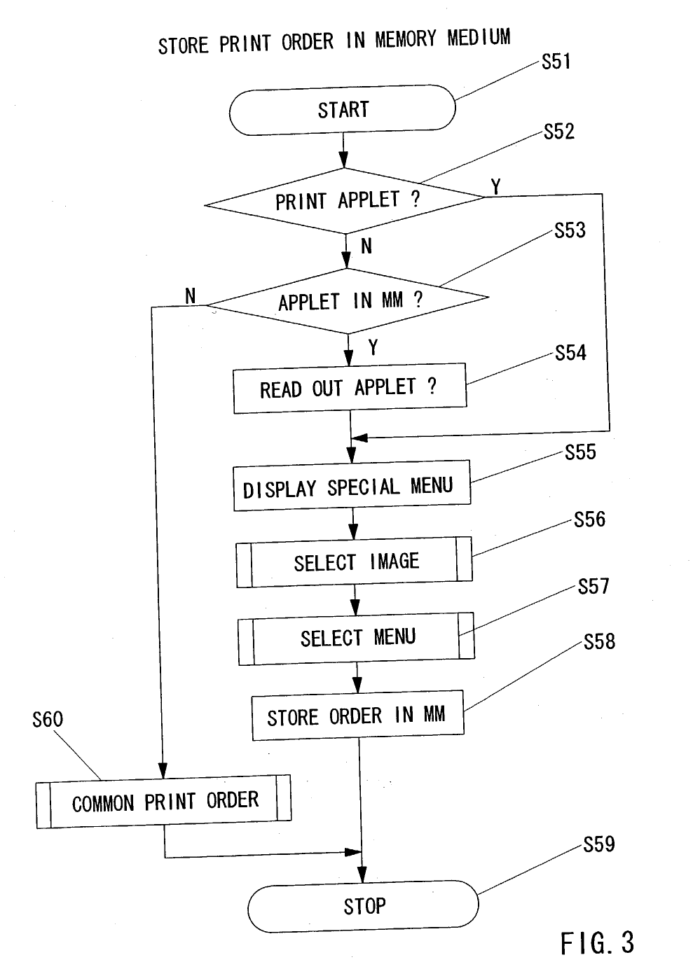

FIG. 5 is a flow chart showing detailed process of storing a print instruction in the memory medium in step S47 shown in FIG. 4. The flow starts from step S51. In step S52, whether or not a special applet for carrying out print instruction storing into the memory medium 10 is stored in the applet memory 11 is checked. Such special applet is supplied not from the printer 2 but from a special printer capable of printing by inserting a memory medium 10 taken out from a digital camera as shown in a example described later or from an applet supply service to the digital camera 1. Various methods for supplying the special applet are possible such as a method through a memory medium, and a method through the Internet as described later. As for the special applet, there are an applet for color-matching between a digital camera and a printer as described above and an applet for displaying a special menu for print instruction.

In step S52, when the special applet for carrying out print instruction storing into the memory medium 10 is not stored in the applet memory 11, the flow proceeds to step S53. In step S53, whether or not the special applet for carrying out print instruction storing into the memory medium 10 is stored in the memory medium 10 is checked. As described above, even the memory medium itself can be memory for an applet as well as the applet memory 11, in this case the digital camera 1 makes it possible to carry out processing in accordance with the special applet by inserting the memory medium 10 into the memory medium slot 9. For example of this special applet, there are an applet for color-matching between a digital camera and a printer and an applet for displaying a special menu for print instruction. When the special applet for carrying out print instruction is stored in the memory medium 10 itself, the flow proceeds to step S54. In step S54, the special applet is read out from the memory medium 10 by the controller/processor 3. In step S55, the special menu for storing the print instruction into the memory medium 10 is displayed on the LCD display 4 by the readout special applet.

On the other hand, when the special applet for carrying out print instruction storing into the memory medium 10 is stored in the applet memory 11, the flow proceeds directly to step S55 and the special menu for storing the print instruction into the memory medium 10 is displayed on the LCD display 4 by the special applet stored in the applet memory 11.

In step S56, a print target image is selected in accordance with the displayed menu. In step S57, menu selection processing for designating a kind of a paper, a paper size, an image size, image quality, color setting, the number of prints, and the like is carried out in accordance with the displayed menu. In step S58, the print instruction is stored in the image file of the selected image stored in the memory medium 10. The print instruction includes not only the items designated by the operating section 5 at menu selection processing but also the items automatically stored on the basis of the color-matching applet. When storing has been completed, the flow proceeds to step S59. In step S59, storing processing into the memory medium is terminated and the flow returned to step S47 shown in FIG. 4.

In step S53, when the special applet for carrying out print instruction storing into the memory medium 10 is not stored, the flow proceeds to step S60. In step S60, the processing for storing a print instruction into the memory medium 10 is carried out on the basis of a general standard for transferring a print instruction from a digital camera to a printer. In this case, the print instruction is within a scope of a general standard and not corresponding to specific printers. When a color-matching standard is included in the general standard, the color-matching data is also stored on the basis of the general standard.

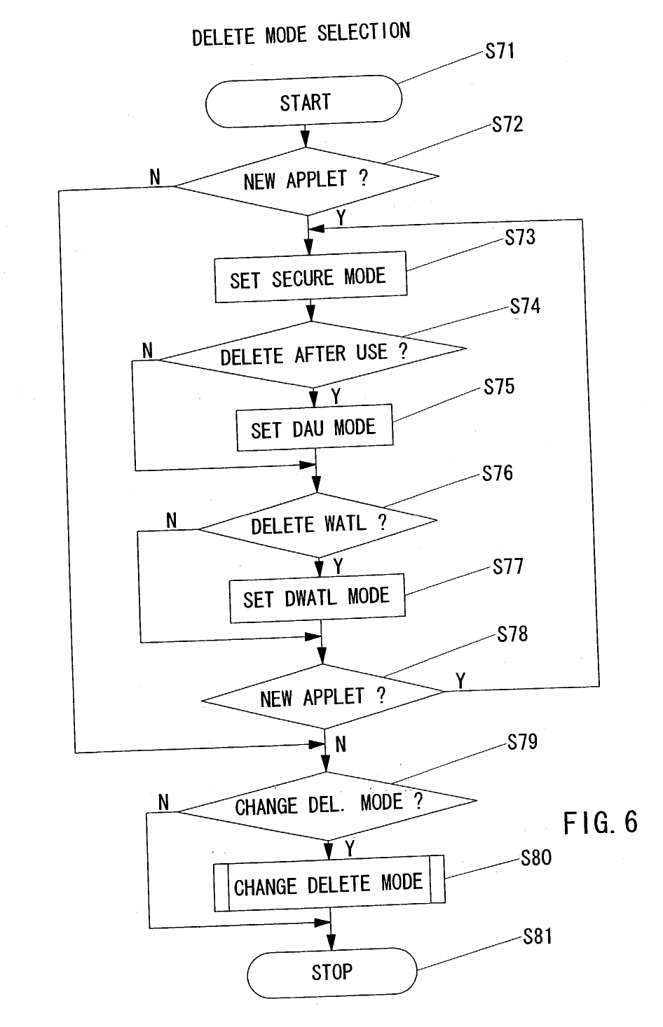

FIG. 6 is a flow chart showing detailed process of delete mode selection processing in step S10 shown in FIG. 2. The flow starts from step S71. In step S72, whether or not a new applet is stored in the applet memory 11 is checked. When a new applet is stored, the flow proceeds to step S73. In step S73, a secure mode is set to one of the new applets by default. In step S74, whether a delete-after-use mode is selected or not by the operating section 5 is checked. When the selection of this mode is detected within a given time period, the flow proceeds to step S75. In step S75, a secure mode is changed to the delete-after-use mode and the flow proceeds to step S76. In step S74, when the selection of the delete-after-use mode is not detected within a given time period, the flow proceeds to step S76 with keeping the secure mode.

In step S76, whether or not a delete-with-a-time-limit mode is selected by the operating section 5 is checked. When the selection of this mode is detected within a given time period, the flow proceeds to step S77. In step S77, the delete-with-a-time-limit mode is set and the flow proceeds to step S78. In step S76, when the selection of the delete-with-a-time-limit mode is not detected within a given time period, the flow proceeds to step S78 skipping step S77. The delete-with-a-time-limit mode is for deleting an applet which has not been used for long period or an old applet from the applet memory.

As a result, one of these delete modes such as a securing mode, a delete-after-using mode, a delete-with-a-time-limit mode, and both delete-after-using mode and delete-with-a-time-limit mode is set.

In step S78, whether or not any other new applet is stored in the applet memory 11 is checked. When there is no other new applet, the flow proceeds to step S79. On the other hand, when there is any other new applet, the flow returns to step S73. As long as any new applet is there, step S73 through step S78 are repeated, so that a delete mode is set to each new applet.

In step S79, whether or not the operation that requests a change in the already set delete mode has been carried out within a given time period by the operation section 5 is checked. When the request for a change is detected, the flow proceeds to step S80 that carries out mode change processing. In step S80, several kinds of processing are carried out such that an applet list stored in the applet memory 11 is displayed on the LCD display 4, one of these applets is selected by the operating section 5, and a selected applet delete mode is changed by the operating section 5. When the mode change processing has completed, the flow proceeds to step S81. In step S81, the flow returns to step S11 shown in FIG. 2. When the operation that requests a change in the already set delete mode has not been carried out within a given time period by the operation section 5, the flow directly proceeds to step S81.

In step S72, when a new applet is not stored in the applet memory 11, the flow directly proceeds to step S79. In this case also, an applet already stored in the applet memory 11 can be changed its delete mode in steps S79 and S80 if necessary.

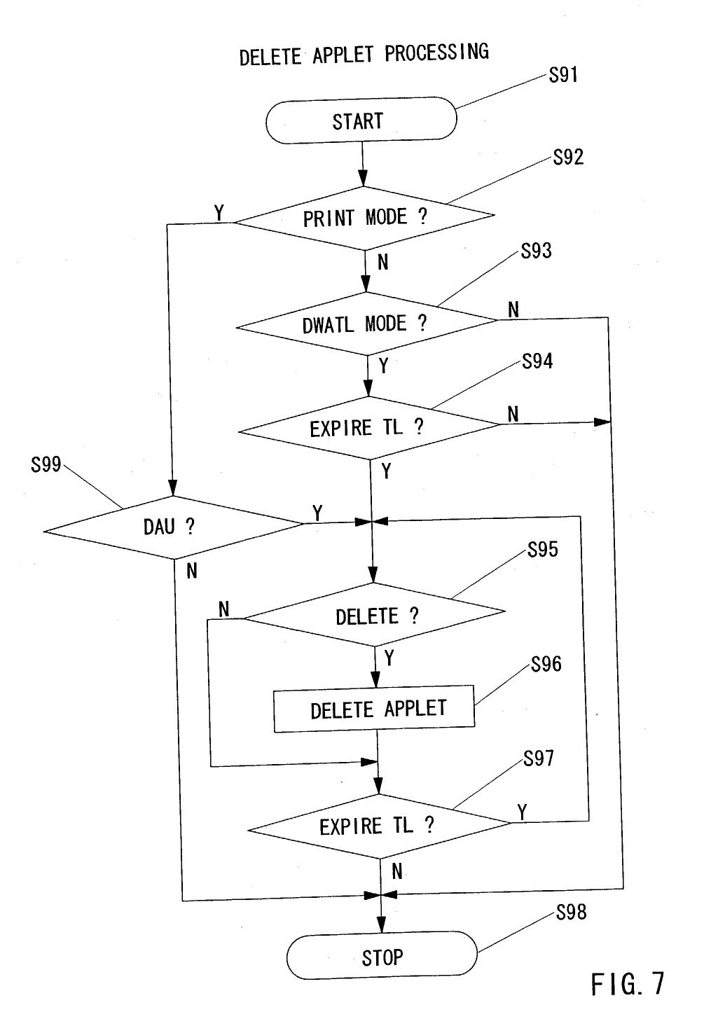

FIG. 7 is a flow chart showing detailed process of delete processing in step S11 shown in FIG. 2 or in step S44 in FIG. 4. The flow starts from step S91. In step S92, whether it is a print mode or not is checked. When it is not a print mode, which corresponds to step S11 shown in FIG. 2, the flow proceeds to step S93. In step S93, whether or not the applet corresponding to the delete-with-a-time-limit mode is stored in the applet memory 11 is checked. Instep S94, whether there is any applet whose the time limit has already passed is checked. Specific examples of expiration of a time limit are such as a case that a given time period from the stored date to the applet memory 11 has passed, a case that a given time period has passed since the latest access, and a case that a given time period has passed since the applet was made. For this purpose, the date when the applet is made, the date when the applet is stored, and the date of the latest access are stored in each applet.

In step S94, when there is any applet whose time limit has already passed, the flow proceeds to step S95. In step S95, whether one of these applets may be deleted or not is displayed on the LCD display 4 and whether an “OK” agreement is operated by the operating section 5 within a given time period is checked. When the operation is detected, the flow proceeds t step S96. In step S96, the applet is deleted from the applet memory 11 and the flow proceeds to step S97. On the other hand, in step S95, when the operation of the “OK” agreement by the operating section 5 is not detected within a given time period, the applet is not deleted and the flow proceeds to step S97.

In step S97, whether there is any other applet whose time limit has already passed is checked. When there is no other applet whose time limit has already passed, the flow proceeds to step S98 terminating the flow and returns to step S12 shown in FIG. 2. On the other hand, when there is still other applet whose time limit has already passed, the flow returns to step S95, after that step S95 through step S97 is repeated until no applet which has not been judged whether or not to be deleted and whose time limit has already passed is there.

In step s93, when the applet corresponding to the delete-with-a-time-limit mode is not stored in the applet memory 11, or in step S94, when there is no applet whose time limit has already passed, the flow directly proceeds to step S98.

In step S91, when the mode is the print mode, it corresponds to step S44 shown in FIG. 4, so that the flow proceeds to step S99. In step S99, whether or not the applet used in the print mode is set to a delete-after-use mode is checked. When the mode is the delete-after-use mode, the flow proceeds to step S95. The following movement is the same as the movement from step S94 to step S95. Even if the flow proceeds to step S95 through step S99, judgment of step S97 is carried out. Accordingly, even if the applet has not been deleted in step S96 in view of delete-after-use, if a delete-with-a-time-limit mode has been set to the applet and the applet is judged in step S97 that the time limit has already passed, the flow returns to step S95 and whether the applet is deleted or not is judged in view of completion of the time limit. In the upper case, when the applet is not set to the delete-with-a-time-limit mode or when the time limit has not passed yet about the applet, the flow proceeds from step S97 to step S98. On the other hand, in step S99, when the applet is not set to the delete-after-use mode, the flow directly proceeds to step S98.

### EXAMPLE 2

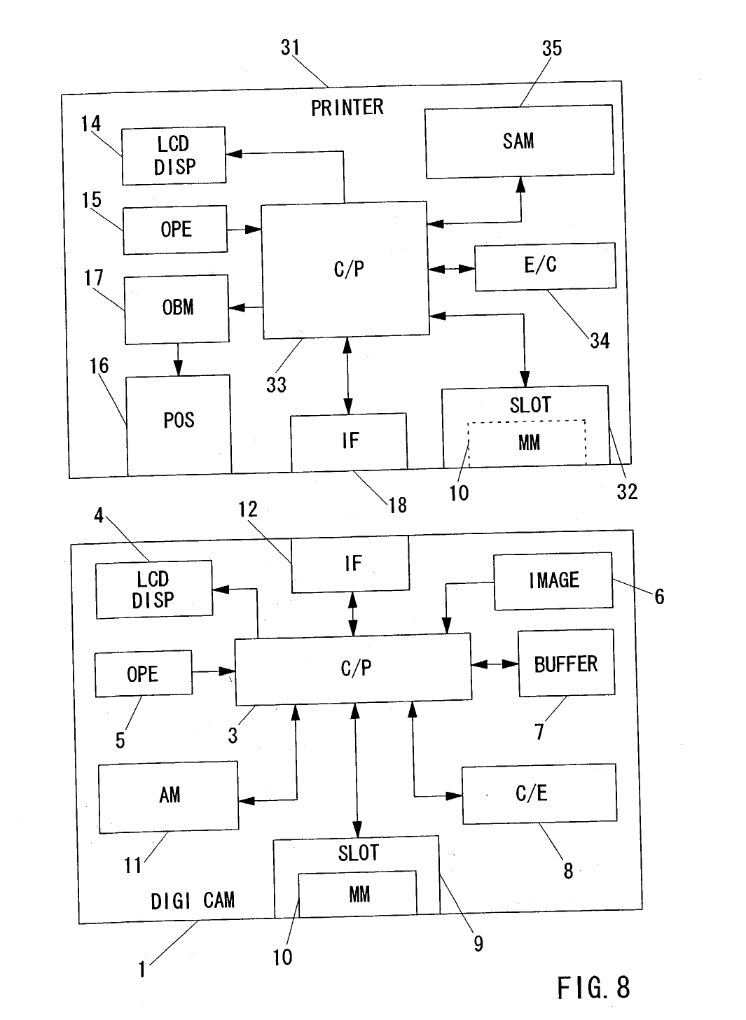

FIG. 8 is a block diagram showing a digital camera system according to Example 2 of the first embodiment of the present invention. The digital camera system is composed of a digital camera 1 and a printer 31.

Since the digital camera 1 according to Example 2 is the same as that according to Example 1 shown in FIG. 1, the same reference number is applied to each element and duplicated explanation is abbreviated. On the other hand, the printer 31 is the one explained with reference to FIG. 5 and can carry out printing by inserting a memory medium 10 taken out from a digital camera. In the printer 31, the same reference number as the printer 2 shown in FIG. 1 is applied to the same construction and duplicated explanation is abbreviated.

The printer 31 has a memory medium slot 32 for inserting a memory medium 10 such as a memory card taken out from the memory medium slot 9 of a digital camera. In the memory medium 10, a print instruction stored by storing processing into the memory medium shown in FIG. 5 is stored as well as compressed image and read out by a controller/processor 33. In particular, the image file which is the print target is read out in accordance with the readout print instruction and the compressed image data is transferred to a expansion/conversion section 34. In the expansion/conversion section 34, the compressed image data is expanded and converted into a special print data for the printer 31. When a color-matching data is stored in the image file, the command is also read out and color-matching processing for processing the image is also carried out. The print data is transferred to the output buffer memory 17 by the controller/processor 33 and the print output section 16 carries out printing based on it.

In the above-described procedure, the color-matching data stored in the image file of the memory medium 10 is originated from a color-matching applet that is stored in an applet special memory 35 of the printer 31, transferred to the digital camera 1, stored in the applet memory 11, and functioned in accordance with the flow shown in FIG. 5 to store the color-matching data in the memory medium by the digital camera 1.

As described above, since the printer 31 according to Example 2 has the expansion/conversion section 34, the printer 31 can read out the image file having the compressed image from the memory medium 10 inserted into the memory slot 32 and generate a print data by itself without receiving a signal converted in a form of a print data by outside.

Various methods for exchanging a special applet according to Example 2 may be possible. At first, there is a method that by connecting the interface 18 to the interface 12 with suitable method, which is the same as Example 1, an applet stored in the applet special memory 35 of the printer 31 is transferred to the applet memory 11 of the digital camera 1.

Then, there is another method that an applet stored in the applet special memory 35 of the printer 31 is stored into the memory medium 10 inserted into the memory medium slot 32, read out and stored in the applet memory 11 when the memory medium 10 is inserted into the memory medium slot 9 of the digital camera 1. In this case, the detailed procedure for inputting the applet from the memory medium 10 to the applet memory 11 can be carried out by a similar flow shown in FIG. 2. In particular, “connect printer” should be rephrased by “insert memory medium”. The case that an applet is there in the applet memory 11 is correspond to the case that, in step S53 shown in FIG. 5, an applet stored from the memory medium exists in the applet memory.

Moreover, there is a third method that an applet stored in the applet special memory 35 of the printer 31 is stored into the memory medium 10 inserted into the memory medium slot 32, and directly read out if necessary to activate the controller/processor 3 while the memory medium 10 is inserted into the memory medium slot 9 of the digital camera 1. In this case, the applet is not stored in the applet memory 11. Accordingly, it is not necessary to delete the applet from the applet memory 11. This case corresponds to step S53 shown in FIG. 5 when the applet is stored in the memory medium 10.

### EXAMPLE 3

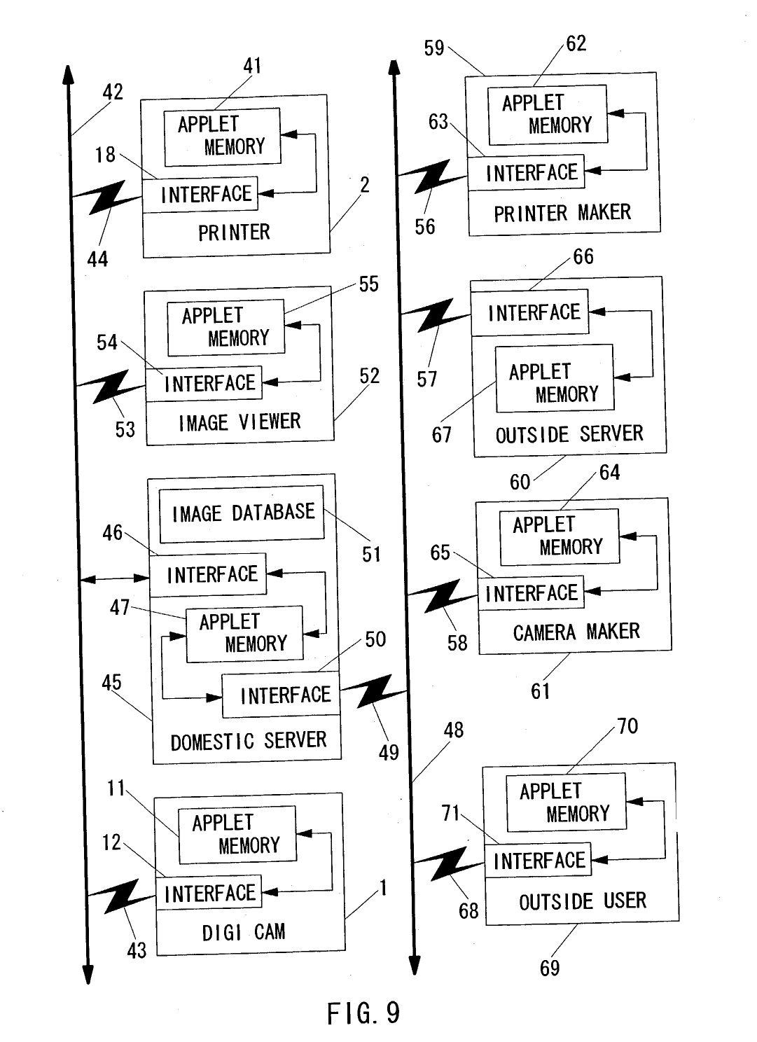

FIG. 9 is a block diagram showing a digital camera system according to Example 3 of the first embodiment of the present invention, which shows the case that each component is connected by a network. A digital camera 1 is basically the same construction as that in Example 1 and its detailed diagram is abbreviated except an applet memory 11 and an interface 12. A printer 2 is also basically the same construction as that in Example 1. However, the printer driver applet memory 19 and the color-matching applet memory 21 shown in FIG. 1 are named generically as an applet memory 41. Detailed diagram of the printer is also abbreviated except the applet memory 41 and the interface 18. Although the printer 31 shown in FIG. 8 is also practicable in Example 3, from the point of view of Example 3 it is the same meaning, so that detailed diagram is abbreviated being represented by the printer 2 shown in FIG. 1. In order to understand this as Example 3 in particular, it can be understood that the applet memory 41 in FIG. 9 corresponds to the applet special memory 35 in FIG. 8.

Although the digital camera 1 and the printer 2 is directly connected by the cable 20 in Example 1, they are connected by a short distance communication means 43, 44 by using a radio wave or infrared light through a domestic wireless LAN 42 in Example 3. A home server 45 such as a personal computer controls the domestic wireless LAN 42 through an interface 46 and has an applet memory 47. The home server 45 receives an applet for a digital camera such as a printer driver applet and a color-matching applet output from the applet memory 41 of the printer 2 to the domestic wireless LAN 42, and temporarily stored in the applet memory 47. When the digital camera 1 communicates with the domestic wireless LAN 42, the home server 45 transfers the applet for a digital camera stored in the applet memory 47 to the digital camera 1. When the printer outputs the applet for a digital camera to the domestic wireless LAN 42 while the digital camera 1 is communicating with the domestic wireless LAN 42, the printer 2 may directly transfer the applet to the digital camera 1 without temporarily storing it into the applet memory 47 of the home server 45.

The home server 45 has an interface 50 corresponding to a communication means 49 with the Internet. When applets corresponding to various domestic devices connected to the domestic wireless LAN 42 is supplied through the Internet 48, the applets are received by the interface 50, temporarily stored in the applet memory 47, and suitably supplied to relevant domestic devices through the domestic wireless LAN 42.

The home server 45 has a image database 51. In the image database, an image file is transferred and stored from the digital camera 1 through the domestic wireless LAN 42. In this case, a data generating applet for the image database prepared in the applet memory 47 of the home server 45 is transferred while the digital camera 1 is communicating with the domestic wireless LAN 42, and stored in the applet memory 11. Accordingly, the digital camera 1 can output an image file suitable for accumulating in the image database 51 on the basis of the data generating applet for the image database of the applet memory 11.

In the domestic wireless LAN 42, an image viewer 52 for viewing the digital image from the digital camera displayed on a large screen can be connected by a short distance communication means 53 by using a radio wave or infrared light. The image viewer 52 has an interface 54 and an applet memory 55 similar to the printer 2. The home server 45 receives an image viewing applet output from the applet memory 55 of the image viewer 52 to the domestic wireless LAN 42 and stores in the applet memory 47. The home server 45 transfers the image viewing applet in the applet memory 47 to the digital camera 1 while the digital camera 1 is communicating with the domestic wireless LAN 42. Similar to the case of the printer 2, when the image viewer 52 outputs the image viewing applet to the domestic wireless LAN 42 while the digital camera 1 is communicating with the domestic wireless LAN 42, the image viewer 52 may directly transfer the image viewing applet to the digital camera 1 without storing the applet in the applet memory 47 of the home server 45. In either case, the digital camera 1 stores the received applet in the applet memory 11. Accordingly, the digital camera 1 can output image data with suitable format and size to the image display of the image viewer 52 on the basis of the image viewing applet stored in the applet memory 11.

The image viewing applet stored in the applet memory 47 of the home server 45 is also used when the image data accumulating in the image database 51 is viewed by the image viewer 52. In this case, the home server expands the image data stored in the image database 51 on the basis of the image viewing applet stored in the applet memory 47 and outputs image data with converting to a suitable format and size to the display of the image viewer 52.

The printer driver applet and the color-matching applet stored in the applet memory 47 of the home server 45 are used when an image data stored in the image database 51 is printed by the printer 2. In this case, the home server expands the compressed image data stored in the image database 51 and outputs with converting the image data stored in the image database 51 into the print data on the basis of the printer driver applet and the color-matching applet stored in the applet memory 47.

In above explanation, the case that the digital camera 1 receives an applet and stores it in the applet memory 11 is explained. On the contrary, it is possible to transfer the applet stored in the applet memory 11 to peripherals. For example, a printer which does not correspond to a color-matching system can be changed to correspond to it by a procedure that a system applet for corresponding a system with which the digital camera 1 and the printer 2 make color-matching is output from the applet memory 11 of the digital camera 11 and transferred to the applet memory 41 of the printer 2 through the domestic wireless LAN 42. Similarly, it is possible that a system applet for corresponding to a system with which the digital camera 1 and the image viewer 52 make color-matching is output from the applet memory 11 of the digital camera 1 and transferred to the applet memory 55 of the image viewer 52 through the domestic wireless LAN 42.

In particular, in above-described case, when color command information for color-matching is written in a given position of the image file in accordance with the system applet on the digital camera side and output to the printer, the command information is read out on the printer side and the system applet for processing image information in the image file in accordance with the command is transferred to the applet memory 41 of the printer 2 in advance. Accordingly, the printer 2 can generate a print corresponding to the color condition of the digital camera 1.

In Example 3 shown in FIG. 9, the digital camera 1 and peripherals are connected by the short distance communication means 43. However, the connection between the digital camera 1 and peripherals is not limited to this. For example, it may be constructed such that a digital-camera cradle having a charger connector for a digital camera and an image-signal connector is connected to the domestic wireless LAN 42, corresponding connectors arranged on the digital camera 1 are connected respectively to the charger connector and the image-signal connector of the cradle, and it becomes possible to charge the digital camera and carry out digital communication through the domestic wireless LAN. In this case, it is possible to be constructed such that an applet memory is arranged to the cradle, and the applet is mutually transferred between the applet memory 11 of the digital camera 1 and that of the cradle. Moreover, it is possible to activate the controller/processor 3 of the digital camera 1 by the applet stored in the cradle.

In FIG. 9, various facilities such as a print maker 59, an outer server 60, and a camera maker 61 can be connected to the Internet through communication means 56, 57, and 58. The printer maker 59 develops applets for being provided to the own product (printer) and its peripherals (including digital cameras), stores them one by one to an applet memory 62, and releases them on the Internet 48 through the interface 63.

The outer server 60 periodically accesses them through the Internet 48 in accordance with an agreement made with the print maker 59 and the camera maker 61, receives released applets from an interface 66, and stores them in an applet memory 67. The outer server 60 periodically transfers new relevant applets in the applet memory 67 to the home server 45 through the Internet in accordance with an agreement made with the home server 45. For this purpose the home server 45 may periodically access to the outer server 60. Accordingly, the home server can obtain a newly provided applet by the printer maker 59 or the camera maker 61 and an upgraded applet in almost real time. The method for transferring the applet stored in the applet memory 47 to the digital camera 1, the printer 2, the image viewer 52, and the like is similar to the method for mutually transferring the applet between the domestic peripherals through the applet memory 47.

Outside users 69 can be connected with the Internet 48 through communication means 68. The outside user 69 has an applet memory 70 for storing a special applet and releases the special applet on the Internet through the interface 71. In examples of these outside users 69, there are personal cellular phones, an administrator of the cellular phone network, a network provider, a personally owned computer, an image provider, and a publisher.

For example, when a personal cellular phone is the outside user 69, it may be constructed such that an applet for generating a waiting frame of a cellular phone is stored in the applet memory 70, and the applet is transferred to the applet memory 11 of the digital camera 1 through the Internet 48 and the domestic wireless LAN 42. In this case, the digital camera 1 reads out image information stored in the memory medium 10, expands it by the compression/expansion section 8, carries out pixel skipping in accordance with the applet received from the cellular phone stored in the applet memory 11, makes it a file size for the display of the cellular phone, carries out processing for a waiting frame, and outputs from the interface 12. The waiting frame output from the digital camera 1 is transferred to the cellular phone that is an outside user 69 through the domestic wireless LAN 42, the home server 45, and the Internet 48. When the digital camera 1 has a communication function, the digital camera 1 can mutually directly transfer the applet and the waiting frame to the cellular phone that is an outside user 69.

In another example, when an image provider is the outside user, an applet for processing electric watermark and an encode applet are stored in the applet memory 70. It may be constructed such that the applets are transferred to the applet memory 11 of the digital camera 1 through the Internet 48 and the domestic wireless LAN 42. In this case, the digital camera 1 reads out image information stored in the memory medium 10, expands it by the compression/expansion section 8, carries out electronic watermark processing and encode processing in accordance with the applets from the image provider stored in the applet memory 11, and compresses it again. The image carried out electronic watermark processing and encode processing as described above is output from the digital camera 1, and transferred to the image provider as an outside user 69 through the domestic wireless LAN 42, the home server 45, and the Internet 48. When the digital camera 1 has a communication function, the digital camera 1 can mutually directly transfer the applet and the processed image frame to the image provider as an outside user 69. When an image is determined to be transferred to the image provider at the time of shooting, the image is carried out electronic watermark processing and encode processing before storing in the memory medium 10, compressed and stored in the memory medium 10. In this case, a compressed image in the memory medium is transferred to the image provider as an outside user 69 as it is. By carrying out security processing such as electronic watermark processing and encode processing in accordance with the image provider an image data can be transferred from the digital camera 1 to the image provider as a outside user 69 through the Internet 48 without anxiety for infringement of copyright and embezzlement.

The function in each Example described above can be suitably accomplished by a computer application program(s), in that case, a computer in which the application program is installed and the peripherals connected to the computer ,if necessary, coincide with the system according to the present invention described above. Accordingly, an application program itself or a memory medium such as a CD-ROM in which the application program is stored to accomplish the function according to the present invention is also within the scope of the present invention.

[Second Embodiment]

### EXAMPLE 4

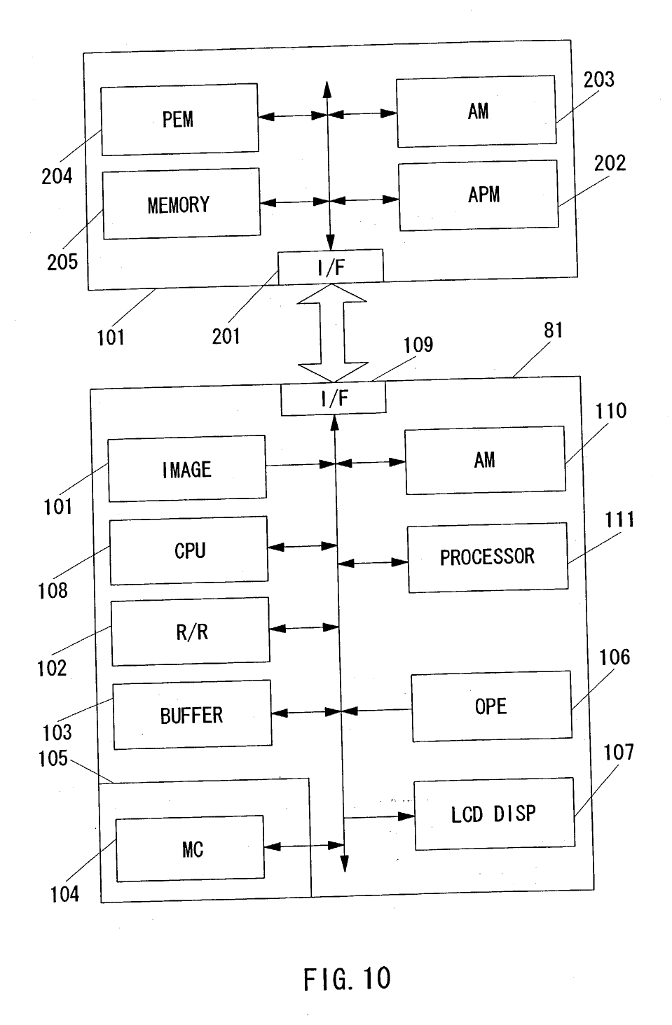

FIG. 10 is a block diagram showing a digital camera system according to Example 4 of a second embodiment of the present invention.

A digital camera 81 is equipped with the functions described below as a usual recording and playback function. There are an imaging section 101 for shooting an object, and a recorder/reproducer 102 for converting an image data into a digital data and carrying out recording/reproducing processing. In the recorder/reproducer 102, processing required for ordinary recording/reproducing such as gamma correction, white balance adjustment, compression/expansion, and the like is carried out. A buffer memory 103 for temporarily storing the image data while processing the signal, a memory card 104 composed of a flush memory and the like, a memory medium slot 105, operating section 106 for carrying out various settings such as setting a shooting condition, selecting image to be reproduced in accordance with the menu display, LCD display 107 for displaying a shot-image and a reproduced image, and a CPU 108 for controlling these procedures are there in the digital camera 81. Each function explained above is indispensable for constructing an ordinary digital camera and other functions indispensable for constructing a digital camera are still there. However, needless functions to explain the present invention are abbreviated. So indispensable functions to explain the present invention are explained. The digital camera 81 has an interface 109 for mutually communicating data with peripherals 82 such as a cellular phone and a game machine, an applet memory 110 for storing special information regarding an application program used in the peripherals 82, and a processor 111 for carrying out given processing on the basis of the special information. The above-described functions, 109 through 111, are also controlled by the CPU 106.

Peripherals 82 communicating data by connecting with the digital camera 81 has an interface 201, an application program memory 202 for storing various application programs such as a game software program, an applet memory 203 for storing special information regarding application programs, a program executing means 204 for carrying out an application program, and a memory 205 for storing an image data that is input from the digital camera 81 and used by the application program. Here, the special information is an applet program that transfers information such as the size, the number of colors, resolution, and shooting direction of a character, a background size in the frame, a scope of the background in the frame, and the like used by the application program to the digital camera and processes the image data on the basis of these information. The application program is, for example, a game software program and the like used by a waiting frame of a cellular phone or a TV phone, a game machine, and a personal computer. In peripherals, functions and operating sections irrelevant to the present invention are abbreviated.

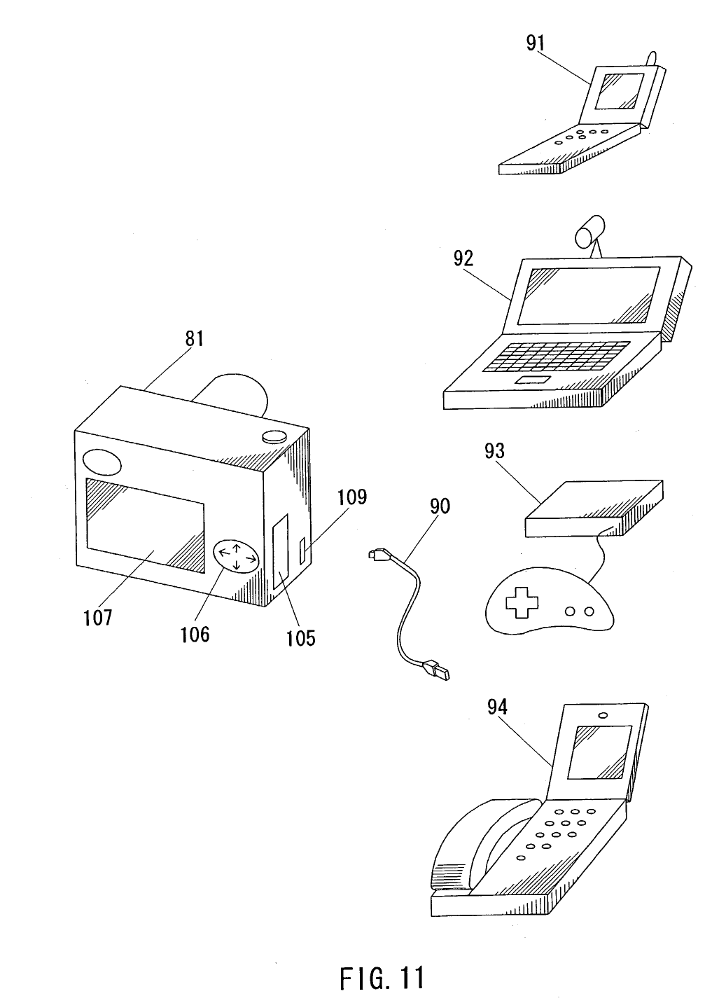

FIG. 11 is a drawing showing a digital camera 81 and typical peripherals connecting to the same. In FIG. 11, a digital camera 81 composed of a memory medium slot 105, an operating section 106, an LCD display 107, an interface 109, and the like is connected to a cellular phone 91, a personal computer 92, a game machine 93, a TV phone, and the like through a cable 90. An image data to be used by the application program on each peripheral is transferred from the digital camera. In FIG. 11, although an example of connection through the cable 90 using USB (Universal Serial Bus) is shown, other wireless connection such as IrDA (Infrared Data Association) may be employed.

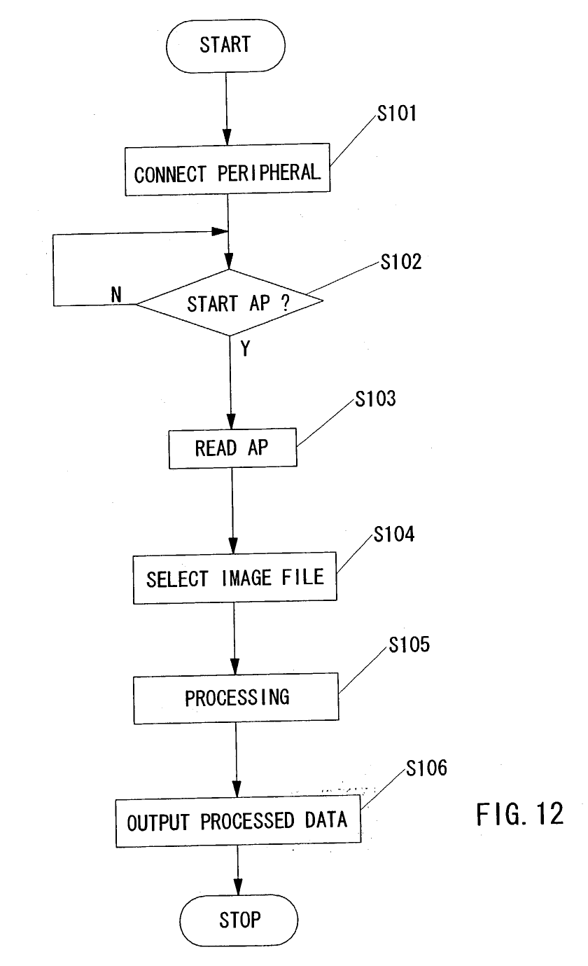

FIG. 12 is a flow chart showing procedure of the digital camera shown by the block diagram of FIG. 10. In step S101, the digital camera 81 detects whether a peripheral 82 is connected or not. In step S102, whether or not an application program starts on the peripheral 82 is checked. When the application program does not start yet, the flow stay in step S102 until the application program starts. When the application program starts, the flow the flow proceeds to step S103. In step S103, the applet program regarding the application program is read out from the peripheral 82. In step S104, an image file for outputting to the peripheral 82 is selected. Here, a shooting direction, the upper half or the whole body of a character is selected on the basis of the applet program, or an object is shot by the imaging section 101 in accordance with the instruction of the applet program. In step S105, the digital camera 81 carries out processing to the selected image file to become given pixels, resolution, and the number of colors. In step S106, the processed image is output to the peripheral 82 through the interface 109.

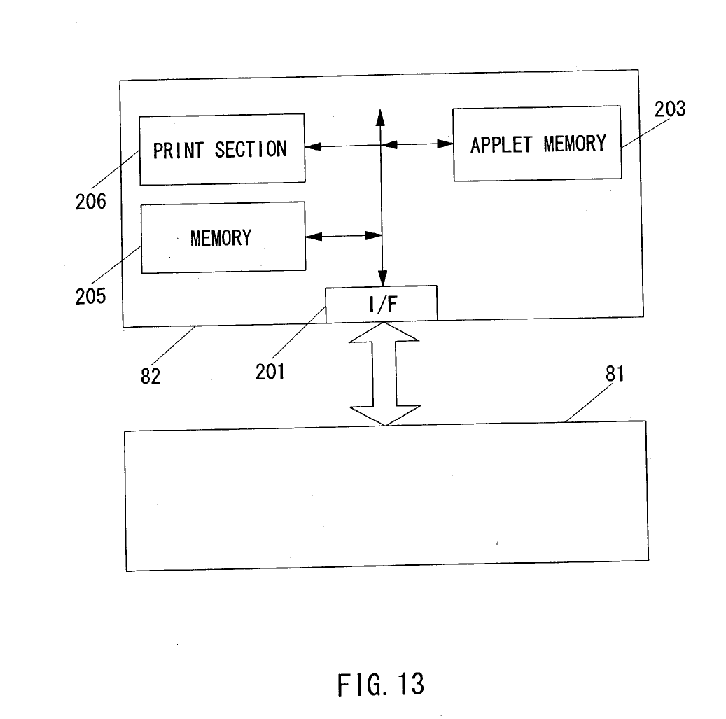

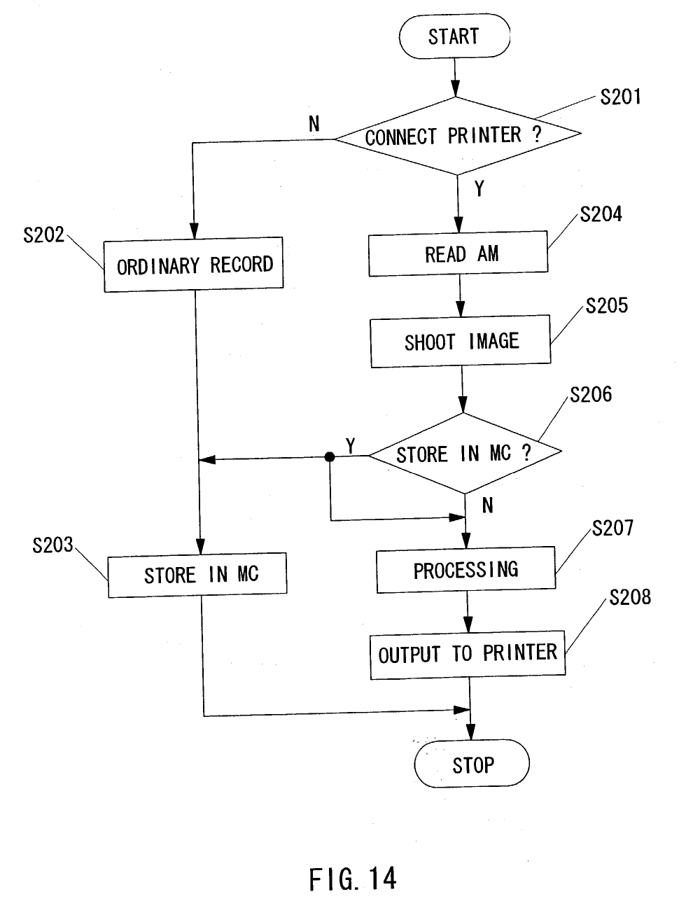

In FIG. 13, the case when a printer 82 is further connected as a peripheral in FIG. 11 is shown. The peripheral 82 has a print section 206 for printing an image data. Here, a program for carrying out printing and outputting a print corresponds to the aforementioned application program. The applet memory includes color-matching information for correcting print characteristics of the print section 206 and the maximum resolution information. The movement of the peripheral 82 shown in FIG. 13 is explained with reference to the flow chart shown in FIG. 14. In step S201 shown in FIG. 14, whether a printer as the peripheral 82 is connected to the digital camera 81 is checked. When the printer is not connected, the flow proceeds to step S202. In step S202, ordinary recording processing is carried out to the shot image. In other words, an image of an object is shot by the imaging section 101, carried out ordinary gamma correction and white balance adjustment, and compressed if necessary. In step S203, the image data is stored in the memory card 104.

In step S201, when the printer is connected to the digital camera, the flow proceeds to step S204. In step S204, an applet program that is special information is read out from the printer. In step S205, an object is shot with a given direction and size on the basis of the readout applet program. In step S206, whether the shot image is to be stored in the memory card or not is checked. When the image is set by the operating section 106 not to be stored in the memory card, the flow proceeds to step S207. In step S207, the image data is carried out color-matching processing, and the like on the basis of the applet program read out in step S204. In step S208, the processed image data is output to the printer. On the other hand, in step S206, when the image is set by the operating section 106 to be stored in the memory card, color-matching processing, and the like are carried out in step S207 and at the same time, is step S203, the shot image data processed with ordinary recording processing is stored in the memory card. At that time, when the memory card has been full, the new image data overwrites the old one in order from oldness.

In view of leaving a shot image data, it is desirable to set to be stored in the memory card. However, in the case of a business use that a camera and a printer is set in the street and the general public are shot and printed in large quantities, you do not have to leave the image data one by one. In that case, it is preferable to set not to be stored in the memory card.

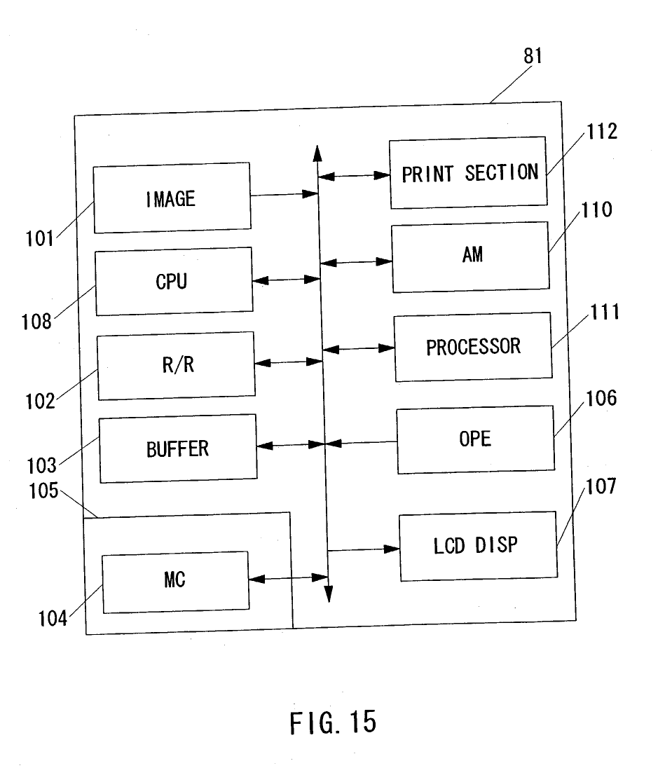

FIG. 15 is a block diagram showing a case that the digital camera and the printer shown in FIG. 13 are combined together. In this case, either one of the applet memories 110 and 203 shown in FIGS. 10 and 13 is enough. The interfaces 109 and 201 can be replaced by a suitable domestic communication means. This is not limited to a digital camera integrated with a printer, but it is similar to the construction that a digital camera and a peripheral is combined in a body such as a game machine or a personal computer equipped with an image acquiring section.

### EXAMPLE 5

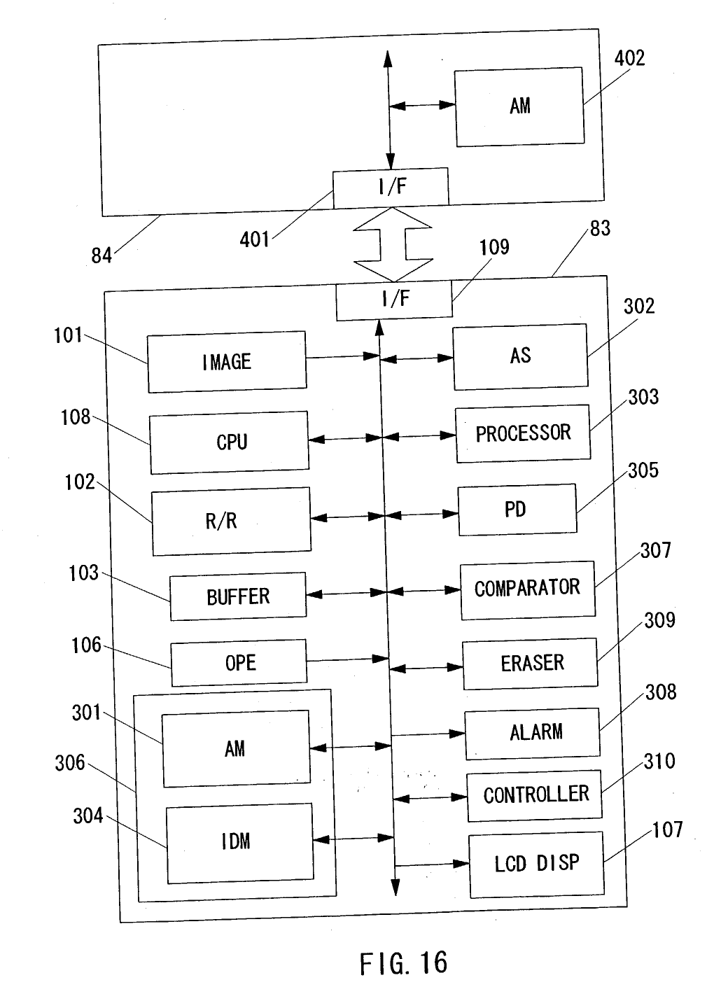

FIG. 16 is a block diagram showing a digital camera system according to Example 5 of the second embodiment of the present invention. In FIG. 16, a digital camera 83 has an imaging section 101, a recorder/reproducer 102, a buffer memory 103, an operating section 106, a display 107, a CPU 108, and an interface 109. Moreover, an applet program including special information corresponding with a plurality of kinds of peripherals 84 capable of connecting to the digital camera 83 is stored in an applet memory 301. Here, the peripheral denotes a printer, a monitor, and a cellular phone including the case that the type is different among the same kind of device.

The special information is an applet program that sends to the digital camera information on which the image data is processed; the information includes the number of pixels, maximum resolution, the number of colors, color-matching information, the maximum resolution of the printer, gamma characteristic of the display, and the like for displaying and printing on each peripheral. An operating section 106 is used for selecting an image from an image data memory 304 and a required applet program from the applet memory 301. The applet program is also selected by an applet selector 302 from the applet memory 301 on the basis of the discriminated result of a peripheral discriminator 305.

A processor 303 carries out given processing to the selected image on the basis of the selected applet program. The processed image data is stored in the image data memory 304. At this time, the processed image is controlled by a controller 310 in connection with the selected image. When a peripheral is connected to the digital camera, the peripheral discriminator 305 discriminates the maker name, the product name, and the serial number of the peripheral and discriminates the applet name corresponding to the peripheral. On the basis of the discriminated result, the applet selector 302 selects a corresponding applet program from the applet memory 301.

When the corresponding applet program is not stored or an ancient applet program is stored in the applet memory, a new applet program is obtained from the peripheral and stored in the applet memory 301. When a plurality of peripherals are connected to the digital camera at a time, the most suitable processed image data is output to each peripheral on the basis of the discriminated result of the peripheral discriminator 305.

The applet memory 301 and the image data memory 304 are located common in a data memory area 306. The special information and the image data are designated respective recording areas by the CPU 108. The common data memory area denotes, for example, image and sound data recording area in a memory card. The image data processed with ordinary recording processing by the recorder/reproducer 102 and that processed by the processor 303 on the basis of the special information are stored together in the image data memory 304. The remaining capacity of the common recording area is displayed on the LCD display 107 as a display.

The applet program name discriminated by the peripheral discriminator 305 and the applet program selected by the applet selector 302 are compared by a comparator 307 whether the two are coincide with each other. When they do not coincide with each other, an alarm 308 warns with a sound for warning. An eraser 309 deletes unnecessary data in the data memory area 306. A peripheral 84 has an interface 401 and an applet memory 402 for storing applet programs including special information regarding the peripheral.

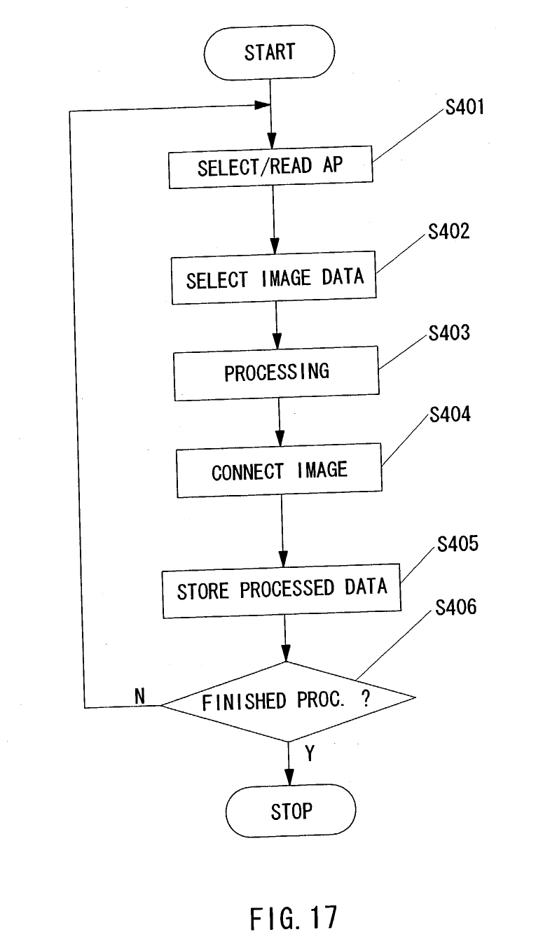

FIGS. 17 through 23 are flowcharts showing movements and an example of the display of the digital camera shown in FIG. 16. In step S401 shown in FIG. 17, applet program names stored in the applet memory 301 of the memory card are displayed on the LCD display 107 by operating the operating section 106, and an applet program is selected from them. In step S402, image data stored in the image data memory 304 of the memory card is similarly readout, displayed on the LCD display 107, and selected an image to be output from the digital camera 83. In step S403, given processing is carried out on the basis of the applet program so as to correspond to the output peripheral.

In step S404, the selected image is connected with the processed image by the controller 310 in accordance with the instruction of the CPU 108 as described above. In step S405, the processed image data is stored in the buffer memory 103 or the image data memory 304 of the memory card. When the image data is to be output to a plurality of peripherals at a time, a plurality of applet programs corresponding to the peripherals are selected, and a plurality of images processed by the applet programs are stored in the image data memory 304 and, at the same time, the selected images are connected with the processed images corresponding to the peripherals.

The connected, processed image data is stored the buffer memory 103 or the image data memory 304 of the memory card by the CPU 108. In step S406, whether all image data to be processed has been processed or not is judged. When the processing has not completed yet, the flow goes back to step S401 and the above-described processes are repeated. When a plurality of applet programs are selected, the processes are repeated similarly. In this manner, a plurality of image data processed with a plurality of applet programs are stored in the digital camera 83 after carrying out a given connection. The timing of the connection is not limited to the example described above; the connection and the disconnection to the processed image can be easily carried out by the controller 310 at any time.

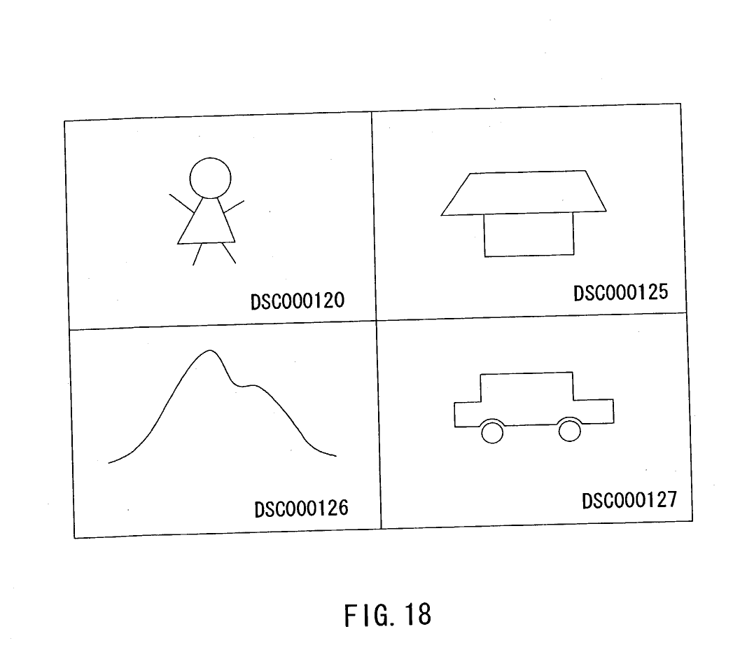

The connection of a processed image data to a selected image is explained with reference to FIG. 18. FIG. 18 is an example of a reproduced image on the LCD display 107. Here, the image contents and the image file name are displayed at a time with the size of a quarter of the frame. From this frame, when an image is selected by the operating section 106, processing corresponding to the applet programs selected in advance in step S401 shown in FIG. 17 is carried out to the image data processed for ordinary recording stored in the image data memory. In this manner, the image and the image file name displayed on the LCD display 107 are connected to the processed image by the controller 310. It is needless to say that the displayed image and the image file name are also connected to the pre-processing image stored in the image data memory. When the processed images corresponding to a plurality of peripherals are there, connection of processed images should be carried out. Accordingly, for example, when a printer and an outside monitor are connected to the digital camera at the same time and an image or an image file name displayed on the outside monitor is selected, a print on the basis of the processed image data controlled in connection with the printer can be output from the printer.

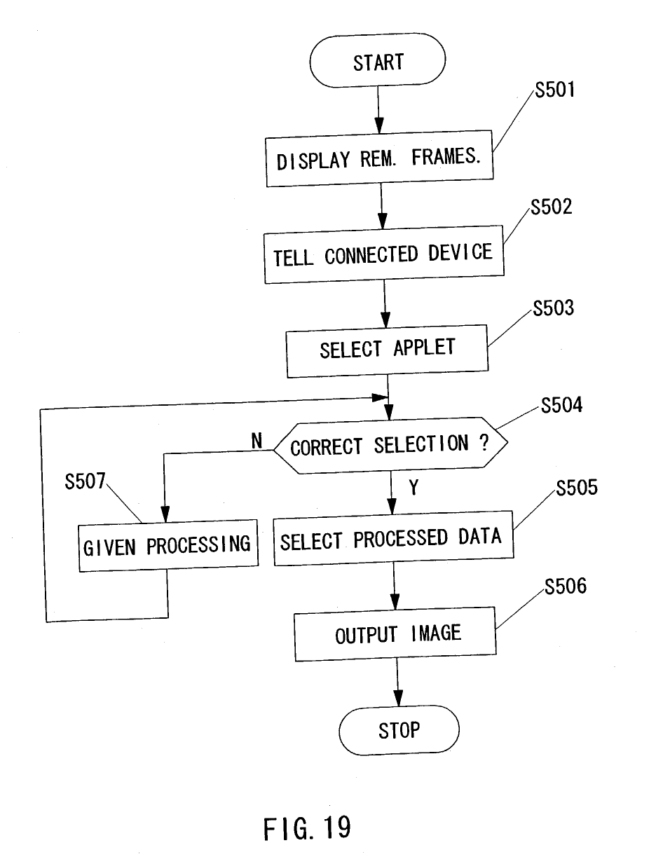

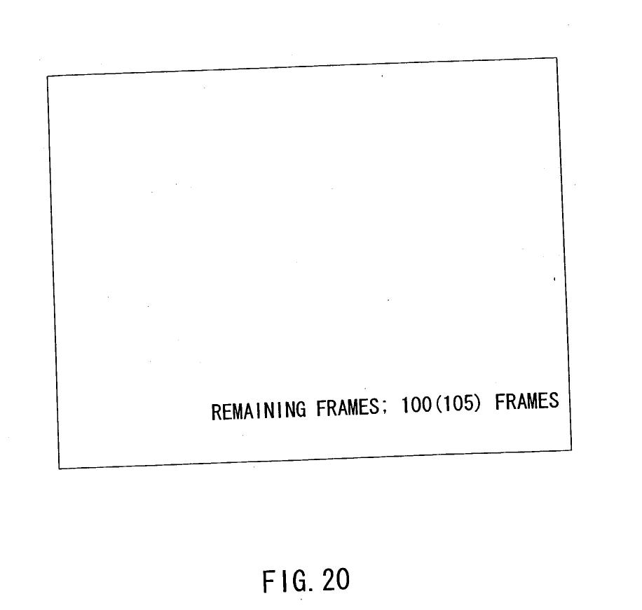

FIG. 19 is a flowchart showing the case that a peripheral is connected to the digital camera 83 after a plurality of image data processed on the basis of the procedure shown in FIG. 17 have been stored in the buffer memory 103 or the image data memory 304 of the memory card. The flow starts when the power of the digital camera is switched on. In step S501, the number of remaining frames in the memory card is displayed on the LCD display 107. FIG. 20 shows an example of a display of the number of remaining frames. In FIG. 20, the figure 100 frames denotes the number of frames capable of being stored excluding an area stored applet programs or processed image data in the memory card. The figure 105 frames in the parenthesis denotes the number of frames capable of being stored if all processed image data or applet programs currently stored in the data memory area are deleted.

In step S502, the kind of the connected peripheral is discriminated by the peripheral discriminator 305. In step S503, a given applet program is selected by the applet selector 302 on the basis of the discriminated result of the peripheral discriminator 305 and displayed on the LCD display 107.

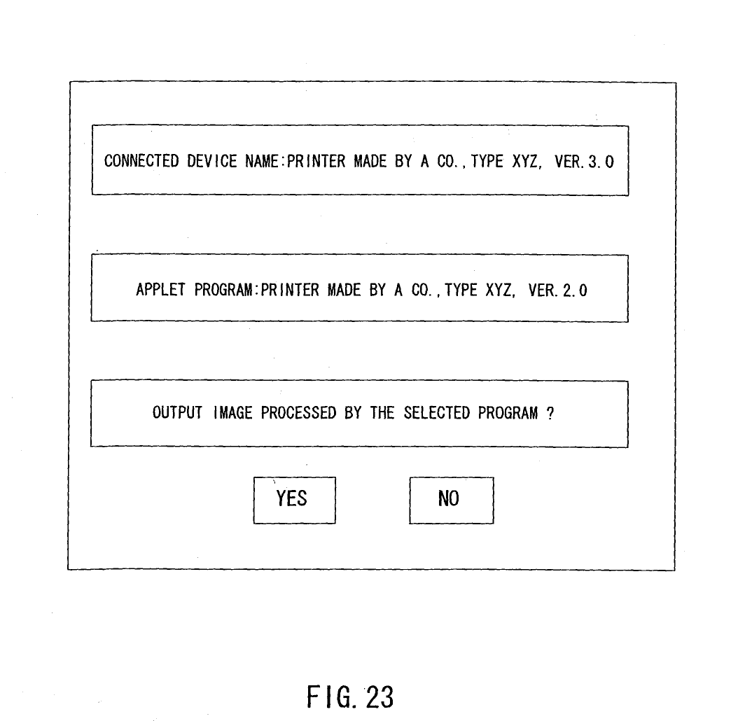

An example of the display is shown in FIG. 23. The example shown in FIG. 23 indicates that the peripheral discriminator 305 discriminates that the peripheral connected to the digital camera 83 is a printer that is produced by A Co., has a model name of XYZ, and has an applet program of Ver. 3.0 stored in the printer. On the other hand, it also indicates that the applet selector 302 selects from the applet memory 301 an applet program, which is the closest one to the discriminated peripheral, that is for a printer produced by A Co. and having a model name of XYZ, and has the program version of Ver. 2.0. In this case, the printer maker and the model name are the same, but an old-version program is stored. In this case, it is effective to call attention by the alarm 308 such as a buzzer.

In step S504, a user checks whether the selection is correct or not. When the user judges that the difference in the version does not matter, and selects “YES”, the flow proceeds to step S505. In step S505, a processed image is selected, and, in step S506, the image is output from the interface 109. When a processed image does not exist, a processed image is formed by the procedure shown in FIG. 17.

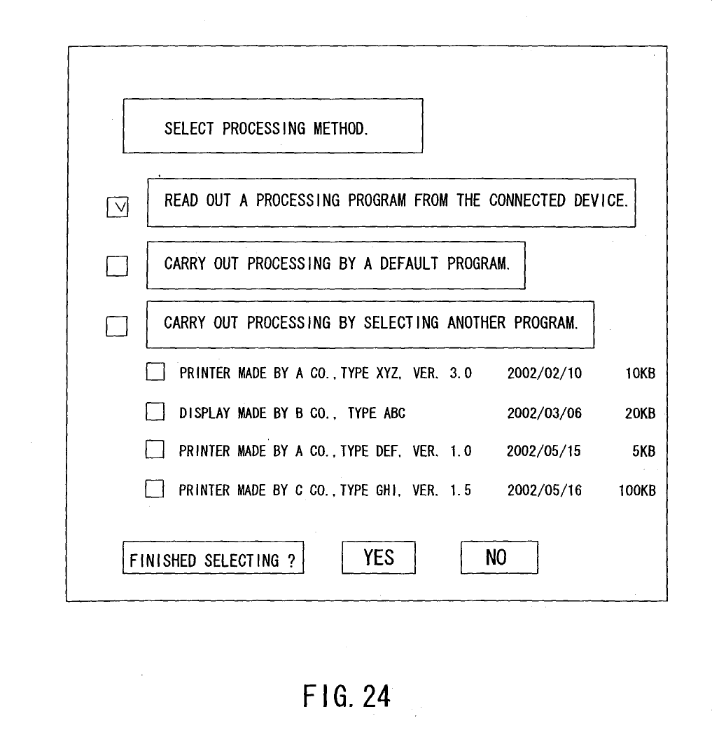

In step S504, when the user selects “NO”, the flow proceeds to step S507. In step S507, a display for selecting another processing applet is shown. A display example shown in FIG. 24 shows three alternatives. The first is a method that newly reads out an applet program from the connected peripheral. The second is a method that carries out processing by a given applet program stored in the digital camera 83 in advance. The third is a method that carries out processing by another applet program selected from currently storing applet programs in the digital camera 83. One method is suitably selected and carried out, and the flow returns to step S504.

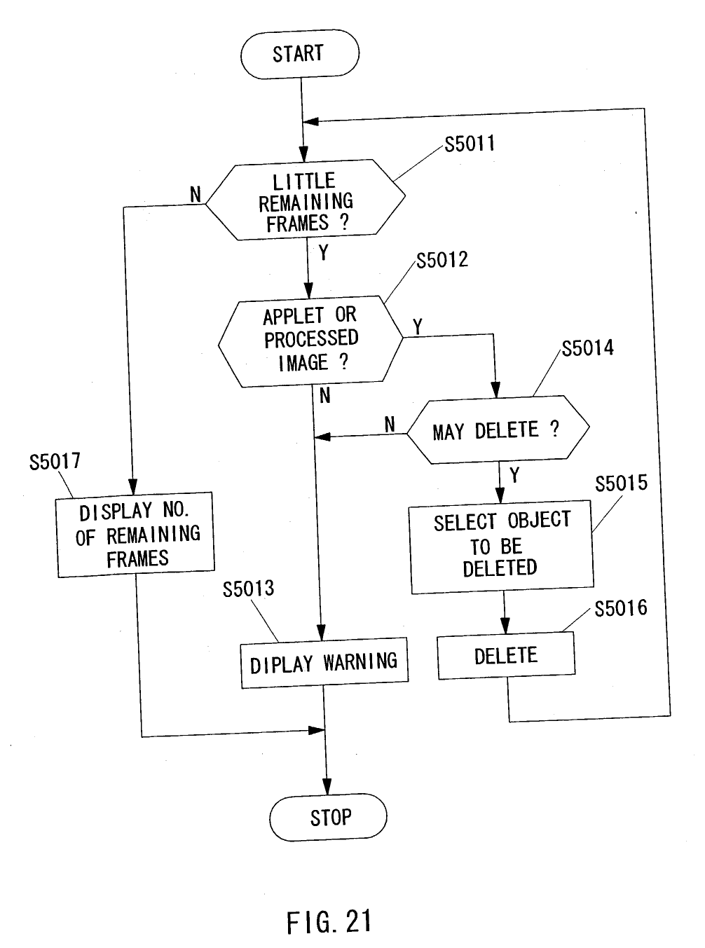

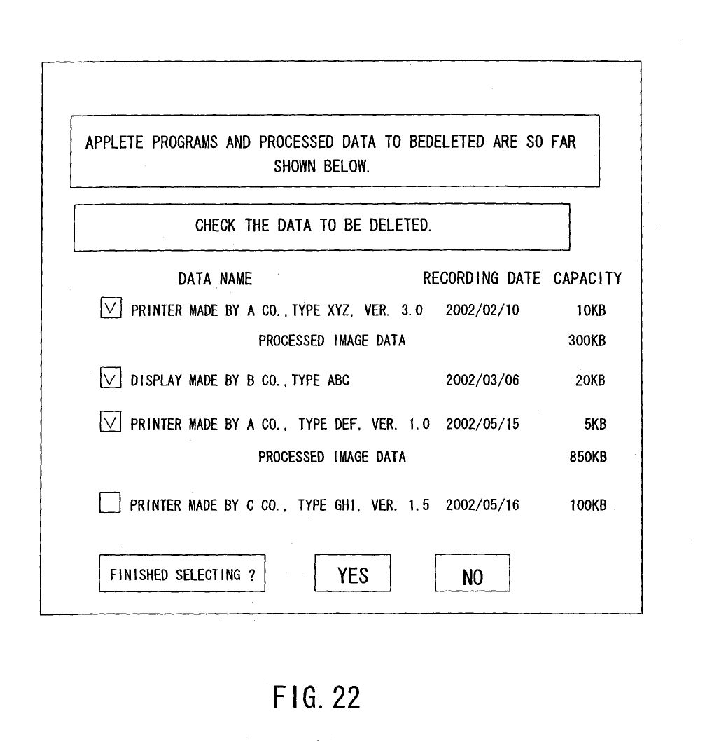

The method to display the number of remaining frames shown in step S501 is explained in detail with reference to FIGS. 21 and 22. In step S5011 shown in FIG. 21, when the number of remaining frames decreases to become a given number, for example, 10 frames, the flow proceeds to step S5012. In step S5012, whether applet programs or processed images are stored in the memory card or not is displayed on the LCD display 107. When no applet program or processed image is stored, only ordinary images are stored, so that the flow proceeds to step S5013. In step S5013, a warning (not shown) that “only a few remaining frames” is shown on the LCD display 107 and the flow terminates.

On the other hand, when an applet program or a processed image is stored, the flow proceeds to step S5014. In step S5014, whether the applet program or the processed image may be deleted or not is displayed on the LCD display 107 as shown in FIG. 22. When the decision is not to delete, the flow proceeds to step S5013. In step S5013, a warning is shown as the same as before and the flow terminates. When a data to be deleted is there, the flow proceeds to step S5015. In step S5015, “delete data” is selected by using the operating section 106. A display example shown in FIG. 22 shows that four kinds of applet programs are currently stored in the applet memory 301, and processed images processed with two kinds of the applet programs out of these four kinds of applet programs are stored in the image data memory. In this display shown in FIG. 22, three kinds of applet programs are checked for deleting.

After that, when “YES” is selected, the flow proceeds to step S5016. In step S5016, the selected data is deleted, and the flow returns to step S5011. In step S5011, when the number of remaining frames is sufficient, the flow proceeds to step S5017. In step S5017, the display shown in FIG. 20 is displayed. By the way, in FIG. 22, although it is shown that an applet program and a processed image data are deleted in a body, an applet program and a processed image data may be selected separately. Moreover, the processed image data may be selected frame by frame.

The method to output processed image data by a user using a suitable way on the basis of the displayed result on the LCD display 107 has been explained up to here. On the basis of the display, it is possible to set that the same procedure to select by the user is automatically carried out by the comparator 307. The procedure after selecting the applet program is the same as the method that a user judges with the help of the display as described above, so that the duplicated explanation is abbreviated. In this case, when the compared result is not identical with each other, a procedure by using the operating section 106 should be prepared in advance.

### EXAMPLE 6

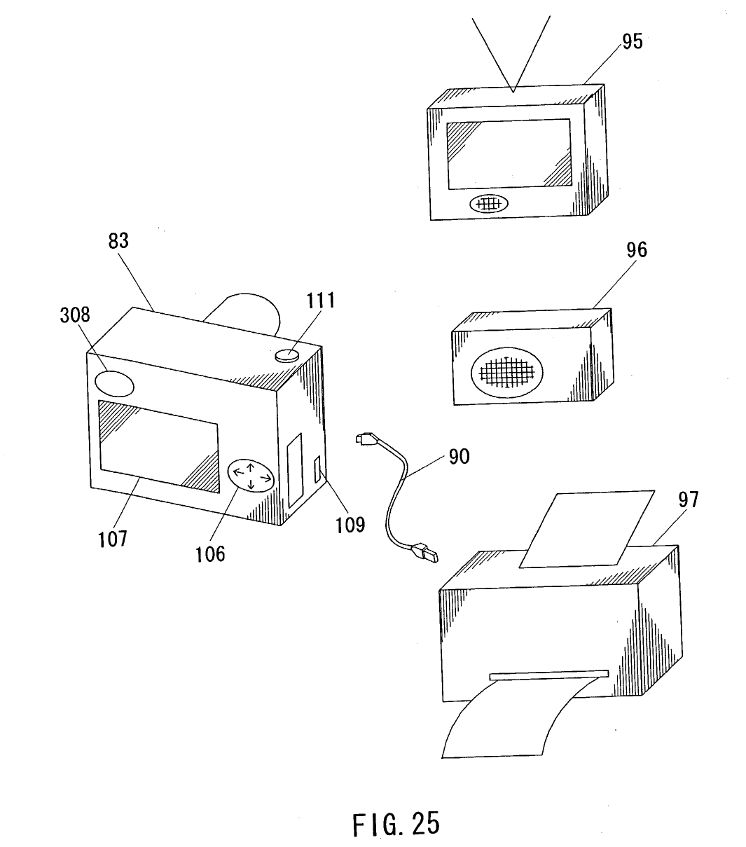

FIG. 25 is a drawing showing a digital camera system connecting peripherals according to Example 6 of the second embodiment of the present invention. In FIG. 25, the digital camera 83 is the same as that shown in the block diagram in FIG. 16, except the image data memory 304 stores a sound data as well as an image data.

In FIG. 25, the digital camera 83 is composed of a LCD display 107, a buzzer 308 as an alarm, a shutter release button 111, an operating section 106 for carrying out various selections, and an interface 109. From the interface 109, the digital camera is connected to a TV monitor 95 for reproducing a sound and an image data, an audio reproducer 96, and a printer 97 through a cable 90.

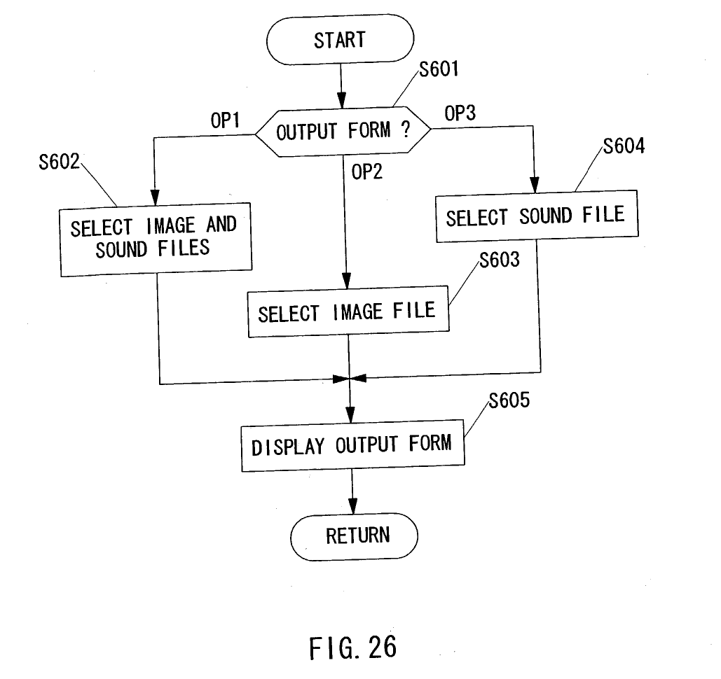

Here, the connecting method may be a wired/wireless method as described before. The movement of Example 6 is explained with reference to the flowchart shown in FIG. 26. The flow starts by connecting a peripheral to the digital camera 83. In step S601, the peripheral is discriminated by the peripheral discriminator 305, and on the basis of the information the CPU 108 selects the output way among three choices. A first output (OP1) is a case that an image file and a sound file are both selected as shown in step S602, which corresponds to the case that the TV monitor 95 is connected. A second output (OP2) is a case that an image file is selected as shown in step S603, which corresponds to the case that the printer 97 is connected. A third output (OP3) is a case that a sound file is selected as shown in step S604, which corresponds to an audio reproducer 96 such as a radio is connected.

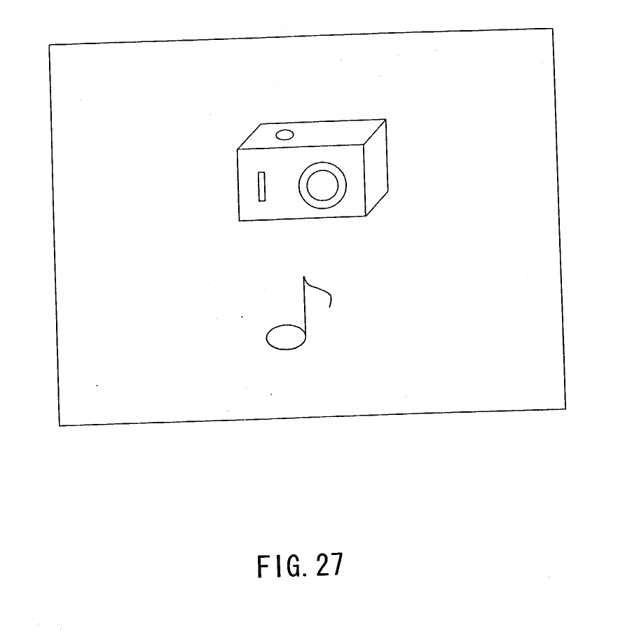

In step S605, after the selection the data output way is displayed on the LCD display 107 until the output has been completed as shown in FIG. 27. FIG. 27 shows the case that an image file and a sound file are both selected or being output. In order to reduce battery drain, the LCD display 107 may be off after a given time period. In this Example 6, the output data output to a peripheral has been processed on the basis of the applet program similar to the case described before.

As described above, in the second embodiment of the present invention, when a peripheral such as a printer is connected to a digital camera, the kind of the connected peripheral and an applet program corresponding to the peripheral are discriminated, on the basis of the discriminated result the closest applet program to the discriminated applet program is selected from applet programs stored in the digital camera, in response to the selected result the final selection is carried out, so that it is prevented that a data mistakenly processed is output.

Additional advantages and modification will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A digital camera comprising;
an input section that inputs special information related to using images by peripherals;
a special memory that stores the special information in advance;
a processor that processes image information to be an output image data in accordance with each peripheral on the basis of the special information stored in the special memory; and
an output section that outputs the output image data processed by the processor to the peripheral.

2. The digital camera according to claim 1, wherein the processor includes a working section that works by a software program and wherein the special information is a software program that works the working section.

3. The digital camera according to claim 1, wherein the input section inputs the special information from the peripheral.

4. The digital camera according to claim 1, wherein the input section inputs the special information from a network capable of being accessed from the input section.

5. The digital camera according to claim 1, wherein the output section outputs the output image data to the peripheral connected to the output section.

6. The digital camera according to claim 1, wherein the output section includes a slot for inserting a memory medium which is removable and outputs the output image data by storing the output image data in the memory medium inserted in the slot.

7. The digital camera according to claim 1, wherein the output section outputs the output image data through a communication means.

8. The digital camera according to claim 1, wherein the special information is indispensable information for the processor to process the image information to have suitable resolution for using by the peripheral.

9. The digital camera according to claim 1, wherein the special information is indispensable information for the processor to process the image information to have suitable image quality for using by the peripheral.

10. The digital camera according to claim 1, wherein the special information is indispensable information for the processor to carry out security processing to the image information.

11. The digital camera according to claim 10, wherein the security processing is to carry out electric watermark processing to the image information.

12. The digital camera according to claim 10, wherein the security processing is to carry out encode processing to the image information.

13. The digital camera according to claim 1, wherein the peripheral is an image viewer and wherein the special information is for processing the image information to be an output image data suitable for being displayed on the. image viewer.

14. The digital camera according to claim 1, wherein the peripheral is an image accumulator and wherein the special information is for processing the image information to be an output image data suitable for being accumulated in the image accumulator.

15. The digital camera according to claim 1, wherein the peripheral is a portable communicator and wherein the special information is for processing the image information to be an output image data suitable for a small display of the portable communicator.

16. The digital camera according to claim 15, wherein the special information is for processing the image information to be an image data suitable for an image frame waiting for a call of the portable communicator.

17. A digital camera comprising;
an input section that inputs special information related to using images by peripherals; and
a special memory that stores a plurality of special information corresponding to a plurality of peripherals.

18. A digital camera comprising;
an input section that inputs special information related to using images by peripherals;
a special memory that stores the special information;
a processor that processes image information to be an output image data in accordance with each peripheral on the basis of the special information stored in the special memory; and
an output section that outputs the output image data processed by the processor to the peripheral;
wherein the special memory keeps storing the special information after the processor finishes processing on the basis of the special information.

19. The digital camera according to claim 18, and further comprising a deletion instructing section that instructs to delete the special information stored in the special memory.

20. A digital camera comprising;
an input section that inputs special information related to using images by peripherals;
a special memory that stores the special information;
a processor that processes image information to be an output image data in accordance with each peripheral on the basis of the special information stored in the special memory;
an output section that outputs the output image data processed by the processor to the peripheral; and
a deleting section that deletes the special information after the processor finishes processing on the basis of the special information.

21. A digital camera system comprising;
a first input section that inputs image information of a digital camera;
a processor that processes the image information of the digital camera input to the first input section;
a keeping section that keeps special information indispensable for carrying out an instruction to the processor;
a peripheral that has a first output section that outputs the special information;
a second input section that inputs the special information;
an instructing section that gives an instruction to the processor in accordance with the special information; and
a second output section that outputs image information together with the instruction from the instructing section.

22. The digital camera system according to claim 21, wherein the digital camera includes a display and wherein the special information includes information that displays on the display an instruction menu for giving an instruction to the processor.

23. The digital camera system according to claim 22, wherein the peripheral is a printer and wherein the instruction menu is a menu for carrying out print instruction.

24. The digital camera system according to claim 21, wherein the second output section outputs the image information together with the instruction from the instructing section in the form of an image file and wherein the special information is indispensable information for storing the instruction from the instructing section to the given part of the image file.

25. The digital camera system according to claim 24, wherein the instruction from the instructing section is automatically carried out on the basis of the special information.

26. The digital camera system according to claim 24, wherein the instruction from the instructing section is given by an operation on the basis of the special information.

27. The digital camera system according to claim 21, wherein the instruction from the instructing section is for instructing that the processor carries out processing for making color-matching upon transferring the image information from the digital camera to the peripheral.

28. A digital camera comprising;
an input section that inputs special information of a peripheral;
an instructing section that instructs the peripheral on the basis of the special information; and
an output section that outputs image information together with the instruction from the instructing section.

29. The digital camera according to claim 28, wherein the input section inputs the special information from the peripheral.

30. The digital camera according to claim 28, wherein the input section inputs the special information from a network capable of being accessed from the input section.

31. The digital camera according to claim 28, wherein the output section outputs the image information together with the instruction from the instructing section to the peripheral connected to the output section.

32. The digital camera according to claim 28, wherein the output section includes a slot for inserting a memory medium which is removable and outputs by storing the image information together with the instruction from the instructing section into the memory medium inserted in the slot.

33. The digital camera according to claim 28, wherein the output section outputs the image information together with the instruction from the instructing section through a communication means.

34. The digital camera according to claim 28, further comprising a display and wherein the special information includes information that displays on the display an instruction menu for giving the instruction to the peripheral.

35. The digital camera according to claim 34, wherein the peripheral is a printer and wherein the instruction menu is a menu for giving a print instruction.

36. The digital camera according to claim 28, wherein the output section outputs the image information together with the instruction from the instructing section in the form of an image file and wherein the special information is indispensable information for storing the instruction from the instructing section to the given part of the image file.

37. The digital camera according to claim 36, wherein the instruction from the instructing section is automatically given on the basis of the special information.

38. The digital camera according to claim 36, wherein the instruction from the instructing section is given by an operation on the basis of the special information.

39. The digital camera according to claim 28, wherein the instruction from the instructing section is for instructing that the peripheral carries out processing for making color-matching upon transferring the image information from the digital camera to the peripheral.

40. A printer comprising;
an input section that inputs image information;
a processor that processes the image information input to the input section; and
a keeping section that keeps special information indispensable for giving an instruction to the processor in order to output to outside.

41. The printer according to claim 40, further comprising an output section that outputs the special information to a digital camera and wherein the image information from the digital camera is input to the input section.

42. The printer according to claim 40, further comprising an output section that outputs the special information to a personal computer and wherein the image information from the personal computer is input to the input section.

43. The printer according to claim 40, further comprising an output section that outputs the special information to a network.

44. The printer according to claim 40, wherein the input section inputs the special information through a network.

45. The printer according to claim 40, wherein the processor processes the image information on the basis of the instruction and has a print output section that outputs a print on the basis of the processed image information.

46. The printer according to claim 45, wherein the processor processes the image information in order to make color-matching upon inputting the image information to the printer from outside.

47. The printer according to claim 40, wherein the processor carries out printing on the basis of the instruction.

48. The printer according to claim 47, wherein the instruction is the number of print.

49. A digital camera system comprising;
a digital camera having a first interface, and a peripheral that has a second interface and deals with a digital color image;
wherein system information indispensable for making color-matching between the digital camera and the peripheral is communicated between the first interface and the second interface.

50. The digital camera system according to claim 49,
wherein the digital camera adds additional information to the image information, and
wherein the system information is information that makes the instruction of the color-matching into one part of the additional information.

51. The digital camera system according to claim 49, wherein the system information is output from the second interface and input from the first interface.

52. The digital camera system according to claim 49, wherein the image information added with the instruction of the color-matching by the system information is output from the first interface and input to the second interface.

53. The digital camera system according to claim 49, wherein the system information is the information that the image information is processed based on the instruction of the color-matching.

54. The digital camera system according to claim 49, wherein the system information is the information that reads out the instruction of the color-matching added to the image information and processes the image information on the basis of the readout instruction.

55. The digital camera system according to claim 49, wherein the system information is output from the first interface and input from the second interface.

56. A digital camera having a controller that keeps system information indispensable to a peripheral for making color-matching between the peripheral and the digital camera in order to transfer the system information to the peripheral.

57. The digital camera according to claim 56, wherein the system information is the information that the image information is processed by the peripheral based on the instruction of the color-matching from the digital camera.

58. The digital camera according to claim 56, wherein the system information is the information that makes the peripheral read out the instruction of the color-matching attached to the image information and process the image information on the basis of the readout instruction.

59. The digital camera according to claim 56, wherein the system information is output to the peripheral and the instruction capable of processing with the system information is output attaching to the image information.

60. The digital camera according to claim 56, wherein the system information is renewed by contacting outside.

61. A printer having a controller that keeps system information indispensable to a digital camera for making color-matching between the digital camera and the printer in order to transfer the system information to the digital camera.

62. The printer according to claim 61, wherein the system information is the information that the instruction of the color-matching capable of being read out by the printer is attached to the image information in the digital camera.

63. The printer according to claim 62, wherein the system information is transferred to the digital camera, and the image information attached with the instruction is received from the digital camera by the system information.

64. The printer according to claim 61, wherein the system information is the information that makes the digital camera process the image information in accordance with the characteristic of the printer in order to make color-matching with the printer.

65. The printer according to claim 64, wherein the system information is transferred to the digital camera, and the image information processed by the system information is received from the digital camera.

66. The printer according to claim 61, wherein the system information is renewed by contacting outside.

67. A digital camera comprising;
an input section that inputs special information characteristic of the function of a peripheral;
a memory that stores the special information;
a working section that works on the basis of the special information stored in the memory;
an output section that outputs an output of the working section for the peripheral; and
a controller that controls the memory.

68. The digital camera according to claim 67, wherein when the special information is not stored in the memory, the controller inputs the special information from the input section and stores in the memory.

69. The digital camera according to claim 67, wherein when the special information is stored in the memory, the controller does not input the special information from the input section nor stores in the memory.

70. The digital camera according to claim 67, wherein in order to control the memory, the controller checks through the input section whether the special information that is not stored in the memory is there or not.

71. The digital camera according to claim 70, wherein upon connecting the peripheral, the controller checks whether the special information is there or not.

72. The digital camera according to claim 70, wherein upon connecting an outside network, the controller checks whether the special information is there or not.

73. The digital camera according to claim 70, wherein the input section has a slot for a memory medium capable of inserting/removing from/to either one of the digital camera and the peripheral and wherein upon inserting the memory medium into the slot, the controller checks whether the special information is there or not.

74. The digital camera according to claim 70, wherein the input section has a connector to a cradle on which the digital camera can be placed, and wherein upon placing the digital camera on the cradle, the controller checks whether the special information is there or not.

75. The digital camera according to claim 70, wherein upon given operation of the digital camera, the controller checks whether the special information is there or not.

76. The digital camera according to claim 67, wherein the memory can store a plurality of sets of special information and has a selector that selects, from the memory, special information for activating the working section on the basis of identification of the peripheral through the input section.

77. The digital camera according to claim 67, wherein the controller deletes the special memory from the memory after the working section has been activated.

78. The digital camera according to claim 77, wherein the controller enables to select whether the special information is deleted from the memory after the working section has been activated.

79. The digital camera according to claim 67, wherein the controller deletes the special information meeting with a given condition from the memory.

80. The digital camera according to claim 79, wherein the controller enables to select whether the special information meeting with a given condition is deleted from the memory.

81. The digital camera according to claim 79, wherein the given condition is a given time to be lapsed.

82. A digital camera comprising;
a connector that connects to an inserting/ejecting member storing special information other than stored by the digital camera peculiar to a function of a peripheral;
a working section that works on the basis of the special information in the inserting/ejecting member connecting to the connector; and
an output section that outputs the output of the working section from the connector.

83. The digital camera according to claim 82, wherein the output section stores the output of the working section in the inserting/ejecting member connecting to the connector.

84. The digital camera according to claim 82, wherein the inserting/ejecting member is a memory medium capable of inserting/ejecting to/from either one of the digital camera and the peripheral and wherein the connector has a slot for the inserting/ejecting member.

85. The digital camera according to claim 82, wherein the inserting/ejecting member is the cradle on which the digital camera can be placed and wherein the connector can be connected to the cradle.

86. A digital camera comprising;
a special information memory that stores special information corresponding to a peripheral;
a data interface that inputs and outputs a data with the peripheral;
a peripheral discriminator that discriminates the kind of the peripheral on the basis of the data input from the data interface upon connecting to the peripheral;
a special information selector that selects a set of special information among a plurality of sets of special information stored in the special information memory; and
a comparator that compares the selected result of the special information selector with the discriminated result of the peripheral discriminator.

87. The digital camera according to claim 86, further comprising an alarm that warns with a sound when the compared result does not give a coincidence.

88. The digital camera according to claim 86, further comprising a processor that processes an image data on the basis of the special information, wherein when the compared result gives a coincidence, the processor processes the image data on the basis of the special information selected by the special information selector.

89. The digital camera according to claim 86, further comprising;
a processor that processes an image data on the basis of the special information;
an image data memory that stores the image data processed by the processor; and
an image data selector that selects the image data processed by the processor on the basis of the special information stored in the special information memory in advance selected by the special information selector when the compared result gives a coincidence.

90. The digital camera according to claim 86, further comprising a processor that processes an image data on the basis of the special information, wherein when the compared result does not give a coincidence, the processor processes the image data on the basis of a given procedure set in advance.

91. The digital camera according to claim 86, further comprising a processor that processes an image data on the basis of the special information, wherein when the compared result does not give a coincidence, the special information selector selects a set of special information other than the special information and the processor processes the image data on the basis of the newly selected special information.

92. The digital camera according to claim 86, further comprising;
a processor that processes an image data on the basis of the special information;
an image data memory that stores the image data processed by the processor; and
an image data selector that selects an image data other than the image data processed by the processor on the basis of the special information stored in the special information memory in advance selected by the special information selector when the compared result does not give a coincidence.

93. The digital camera according to claim 86, further comprising a processor that processes an image data on the basis of the special information, wherein when the compared result does not give a coincidence, a set of special information regarding the peripheral is input from the data interface and the processor processes the image data on the basis of the newly input special memory.

94. A digital camera comprising;
a special information memory that stores special information corresponding to a peripheral;
a data interface that inputs and outputs a data with the peripheral;
a peripheral discriminator that discriminates the kind of the peripheral on the basis of the data input from the data interface upon connecting to the peripheral;
a special information selector that selects a set of special information among a plurality of sets of special information stored in the special information memory; and
a display that displays the selected result of the special information selector and the discriminated result of the peripheral discriminator.

95. The digital camera according to claim 94, further comprising an alarm that warns with a sound when the discriminated result of the peripheral discriminator and the selected result of the special information selector shown on the display do not give a coincidence.

96. The digital camera according to claim 94, further comprising;
a processor that processes an image data on the basis of the special information; and
a manual setter that sets such that the processor processes the image data on the basis of the special information selected by the special information selector when the discriminated result of the peripheral discriminator and the selected result of the special information selector shown on the display gives a coincidence.

97. The digital camera according to claim 94, further comprising;
a processor that processes an image data on the basis of the special information;
an image data memory that stores the image data processed by the processor; and
a manual setter that sets such that when the discriminated result of the peripheral discriminator and the selected result of the special information selector shown on the display gives a coincidence, the image data processed on the basis of the special information selected by the special information selector stored in the special information memory in advance is selected.

98. The digital camera according to claim 94, further comprising;
a processor that processes an image data on the basis of the special information; and
a manual setter that sets such that the processor processes the image data on the basis of a given procedure set in advance when the discriminated result of the peripheral discriminator and the selected result of the special information selector shown on the display do not give a coincidence.

99. The digital camera according to claim 94, further comprising;
a processor that processes an image data on the basis of the special information; and
a manual setter that sets such that the special information selector selects a set of special information other than the special information and the processor processes the image data on the basis of the newly selected special information when the discriminated result of the peripheral discriminator and the selected result of the special information selector shown on the display do not give a coincidence.

100. The digital camera according to claim 94, further comprising;
a processor that processes an image data on the basis of the special information;
an image data memory that stores the image data processed by the processor; and
a manual setter that sets such that when the discriminated result of the peripheral discriminator and the selected result of the special information selector shown on the display do not give a coincidence, a processed image data other than the image data processed on the basis of the special information selected by the special information selector stored in the special information memory in advance is selected.

101. The digital camera according to claim 94, further comprising;
a processor that processes an image data on the basis of the special information; and
a manual setter that sets such that when the discriminated result of the peripheral discriminator and the selected result of the special information selector shown on the display do not give a coincidence, the special information regarding the peripheral is input from the data interface and the processor processes the image data on the basis of the special information.

102. The digital camera according to claim 86, wherein the special information is at least one of an image size output from the peripheral, the number of colors displayed on the display, resolution, direction of a shot object, color-matching information of the printer, maximum resolution of the printer, and gamma characteristic of the display.

103. A digital camera comprising;
a peripheral discriminator that discriminates the kind of a connected peripheral;
an output way selector that selects the data output way on the basis of the discriminated result of the peripheral discriminator;
an output section that outputs a selected data selected by the output way selector; and
a display that shows the output way which is the selected data selected by the output selector.

104. The digital camera according to claim 103, wherein the peripheral is a sound-and-image reproducer, and the way of output is an image data and a sound data.

105. The digital camera according to claim 103, wherein the peripheral is a sound reproducer, and the way of output is a sound data.

106. The digital camera according to claim 103, wherein the peripheral is a printer, and the way of output is an image data.

107. A digital camera comprising;
a shooting section that shoots an object;
an instructing section that instructs the shooting section to start shooting;
an image data memory that stores an image data shot by the shooting section on the basis of an instruction given by the instructing section;
an input section that inputs by a user's operation information to convert the image data read out from the image data memory to a suitable data format for outputting from a printer;
an information memory that stores the information in advance;
a processor that processes the image data to become a special output image data corresponding to the printer on the basis of the information stored in the information memory; and
an output section that outputs the output image data processed by the processor to the printer.

108. A digital camera comprising;
an instructing section that instructs to input special information related to using images by peripherals;
an input section that inputs the special information in response to the instruction made by the instructing section;
a special information memory that stores the special information in advance;
a processor that processes the image information to become an output image data corresponding to each special information of each peripheral on the basis of the special information stored in the special information memory; and
an output section that outputs the output image data processed by the processor to the peripheral.

109. The digital camera according to claim 108, further comprising an operating section that is operated by a user, wherein the instructing section instructs in response to the operation made by the user through the operating section.
